(19) United States
(12) Patent Application Publication
(10) Pub. No.: US 2017/0005971 A1
(43) Pub. Date: Jan. 5, 2017

(54) METHOD AND SYSTEM FOR DATA COMMUNICATION

(71) Applicant: Samsung Electronics Co., Ltd., Suwon-si (KR)

(72) Inventor: Sumit KUMAR, Haryana (IN)

(21) Appl. No.: 15/193,701

(22) Filed: Jun. 27, 2016

(30) Foreign Application Priority Data
Jun. 30, 2015 (IN) 1970/DEL/2015
May 16, 2016 (KR) 10-2016-0059757

(51) Int. Cl. H04L 12/58; H04L 29/06; H04L 12/24

(52) U.S. Cl. CPC H04L 51/18; H04L 41/22; H04L 51/04; H04L 69/22; H04L 51/08

(57) ABSTRACT

A method of sending deferred files from a sender to a recipient and a method of deferred receiving of the files thus sent are provided. The method of sending deferred files helps in avoiding cumbersome tasks at the sender end. The deferred receiving, on the other hand, assists in easy storing and collective rendering of the files thus received at the recipient end.

### CROSS-REFERENCE TO RELATED APPLICATION(S)

This application claims the benefit under 35 U.S.C. §119 (a) of an Indian patent application filed on Jun. 30, 2015 in the Indian Patent Office and assigned Ser. No. 1970/DEL/2015, and of a Korean patent application filed on May 16, 2016 in the Korean Intellectual Property Office and assigned Ser. No. 10-2016-0059757, the entire disclosure of each of which is hereby incorporated by reference.

### TECHNICAL FIELD

The present disclosure relates to a communication method. More particularly, the present disclosure relates to a deferred data communication method and to computing devices implementing the same.

### BACKGROUND

Messages which are communicated, such as e-mails, chat messages or device-to-device transmission, may have associated digital files or other content items including attachments such as images, audio, video, data files, etc. In the communication methods of the related art, each time a new file or attachment is to be sent in respect of a communication, the sender may be required to write up a new mail or initiate a new communication session and send the same to the recipient. This tends to generate unnecessary clutter in the system where the messages are received.

The above information is presented as background information only to assist with an understanding of the present disclosure. No determination has been made, and no assertion is made, as to whether any of the above might be applicable as prior art with regard to the present disclosure.

### SUMMARY

Thus, where a number of attachments are to be sent to one or more recipient, and the attachments may be available only at a later time period or may have been inadvertently not sent, there is a need for an intuitive method for communicating such attachments. This summary is provided to introduce a selection of concepts in a simplified format that are further described in the detailed description of the present disclosure. This summary is not intended to identify key or essential inventive concepts of the claimed subject matter, nor is it intended for determining the scope of the claimed subject matter.

Aspects of the present disclosure are to address at least the above-mentioned problems and/or disadvantages and to provide at least the advantages described below. Accordingly, an aspect of the present disclosure is to provide a method for sending deferred files from a sender to a recipient. As an example, user device A either sends or receives a first communication with regard to user device B. The user device A can now send one or more data units as a deferred data unit to user device B. During the process of sending the one or more data units, User device A selects an identifier which may be selected from a group comprising of a transaction identity, an application identity, a context identity, a previously sent file name, a previously sent file's time stamp, a deferred folder name, or a combination thereof. The identifier is then associated to the one or more data units and sent to the recipient. User device B receives the one or more data unit sent in the form of a deferred data unit and, based on the identifier, identifies the previous communication. User device B then stores the one or more data units in association with the previous communication thus identified. In response to a request for rendering, the previous communication and the one or more data units received as deferred data units are bound together and rendered.

The method as described above allows for managing deferred data communication which is intuitive to multiple domains. In particular, the method of deferred data transmission can be adopted in a wide range of communication modes including for example an e-mail communication mode, a short-range communication mode or an instant messaging communication mode, etc.

In accordance with an aspect of the present disclosure, an electronic device is provided. The electronic device includes an input device, a communication interface, a processor, and a memory storing computer program instructions configured, working with the processor, to cause the electronic device at least to send first data to an external device, receive a selection of second data for transmission to the external device, associate an identifier with the second data based on the first data, and send the second data along with the identifier associated thereto to the external device.

In accordance with another aspect of the present disclosure, an electronic device is provided. The electronic device includes an input device, a communication interface, a processor, and a memory storing computer program instructions configured, working with the processor, to cause the electronic device at least to receive first data along with an identifier from an external device, detect in a memory of the electronic device second data corresponding to the identifier, and store the first data in association with the detected second data.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a schematic flow diagram of a deferred data communication method between a sender device and a recipient device according to an embodiment of the present disclosure;

FIG. 2 illustrates a flowchart of a method of deferred data transmission according to an embodiment of the present disclosure;

FIG. 3 illustrates a flowchart of a method of deferred data transmission according to another embodiment of the present disclosure;

FIG. 4 illustrates a flowchart of a method of deferred data transmission according to yet another embodiment of the present disclosure;

FIGS. 5A to 5D illustrate a schematic flow diagram of a method of deferred data transmission via an e-mail system according to an embodiment of the present disclosure;

FIGS. 6A to 6C illustrate a schematic flow diagram of a method of deferred data transmission via an e-mail system according to another embodiment of the present disclosure;

FIG. 7 illustrates a schematic flow diagram of a method of deferred data communication in a deferment aware e-mail system according to an embodiment of the present disclosure;

FIG. 8 illustrates a format of a header which may be adopted to make a communication system a deferment aware system according to an embodiment of the present disclosure;

FIG. 9 illustrates a detailed view of an e-mail header as may be adopted in a deferment aware e-mail system according to an embodiment of the present disclosure;

FIGS. 10A and 10B illustrate a method for marking an email as carrying a deferred attachment according to an embodiment of the present disclosure;

FIG. 11 illustrates a pop-up which may notify a user about an error according to an embodiment of the present disclosure;

FIG. 12 illustrates a schematic flow diagram of a method of deferred data communication in a deferment non-aware e-mail system according to an embodiment of the present disclosure;

FIGS. 13A to 13E illustrate a schematic flow diagram of a method of deferred data transmission via a deferment non-aware e-mail system according to an embodiment of the present disclosure;

FIGS. 14A to 14E illustrate a schematic flow diagram of a method of deferred data transmission via an instant messaging system according to an embodiment of the present disclosure;

FIGS. 15A to 15E illustrate a schematic flow diagram of a method of deferred data transmission via an instant messaging system according to yet another embodiment of the present disclosure;

FIG. 16 illustrates a schematic flow diagram of a method of deferred directory transmission via an instant messaging system according to an embodiment of the present disclosure;

FIGS. 17A and 17B illustrate a schematic flow diagram of a method of deferred transmission of multiple directories via an instant messaging system according to another embodiment of the present disclosure;

FIGS. 18A and 18B illustrate a schematic flow diagram of adding comments to data under deferred transmission and transmission of the same according to another embodiment of the present disclosure;

FIGS. 19A to 19E illustrate a schematic flow diagram of a method of deferred image transmission a via short range communication mode according to an embodiment of the present disclosure;

FIGS. 20A to 20E illustrate a schematic flow diagram of a method of deferred audio transmission a via short range communication mode according to another embodiment of the present disclosure;

FIG. 21 illustrates a flowchart of a method of deferred data reception according to an embodiment of the present disclosure;

FIG. 22 illustrates a flowchart of a method of deferred data reception according to another embodiment of the present disclosure;

FIG. 23 illustrates a sample rendering of an e-mail along with a deferred attachment according to an embodiment of the present disclosure;

FIG. 24 illustrates a sample rendering of an e-mail along with a deferred attachment according to another embodiment of the present disclosure;

FIG. 25 illustrates a sample notification as provided on a receiver device in response to receiving deferred data via an instant messaging system according to another embodiment of the present disclosure;

FIGS. 26A and 26B illustrate a sample rendering of a deferred directory as received via a short range communication mode according to an embodiment of the present disclosure;

FIGS. 27A to 27C illustrate a sample rendering of a reconstituted video file according to an embodiment of the present disclosure;

FIG. 28 illustrates a block diagram of a computing device adapted for implementing a deferred transmission method according to an embodiment of the present disclosure;

FIG. 29 illustrates a block diagram of a computing device adapted for implementing a deferred reception method according to an embodiment of the present disclosure;

FIG. 30 illustrates a block diagram of an e-mail system adapted for implementing a deferred communication method according to an embodiment of the present disclosure;

FIG. 31 illustrates a general storage entry in a receiver side email handling system according to an embodiment of the present disclosure;

FIG. 32 illustrates storage entries of emails from a deferment aware system without any deferred attachment according to an embodiment of the present disclosure;

FIG. 33 illustrates storage entries of emails from a deferment aware system with deferred attachments according to an embodiment of the present disclosure;

FIG. 34 illustrates storage entries of emails from a deferment non-aware system without any deferred attachment according to an embodiment of the present disclosure;

FIG. 35 illustrates storage entries of emails from a deferment non-aware system with deferred attachments according to an embodiment of the present disclosure;

FIG. 36 illustrates a flowchart of a process as implemented by a view controller for detecting whether an e-mail comes from a deferment aware system or a deferment non-aware system according to an embodiment of the present disclosure;

FIG. 37 illustrates a flowchart of a process as implemented by a view controller for detecting deferred attachments in case an e-mail comes from a deferment aware system according to an embodiment of the present disclosure;

FIG. 38 illustrates a flowchart of a process as implemented by a view controller for detecting deferred attachments in case an e-mail comes from a deferment non-aware system according to an embodiment of the present disclosure;

FIG. 39 illustrates a pointer structure in emails with deferred attachments as coming from a deferment aware system according to an embodiment of the present disclosure;

FIG. 40 illustrates a pointer structure in emails with deferred attachments as coming from a deferment non-aware system according to an embodiment of the present disclosure;

FIG. 41 illustrates unique utilities that can be included while handling email attachments in an e-mail system implementing a deferred communication method according to an embodiment of the present disclosure; and

FIG. 42 illustrates a typical hardware configuration of a computing device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Various embodiments of the present disclosure will be described below in detail with reference to the accompanying figures.

A sender device may send some data to a recipient at first and then related data (i.e., deferred data) and an identifier to the recipient device. The relation between the first sent data and the last sent data may be identified by the recipient device using the identifier sent along with the first sent data. In view of a user, transmission of the related data is identified like being deferred. Therefore, according to various embodiments of the present disclosure, the related data may refer to the deferred data. For example, the sender device may send a user's comment to the recipient device first and send a file as the deferred data to the recipient device. The recipient device may notify a recipient of the receiving of the e-mail (i.e. the comment and the file). According to an embodiment of the present disclosure, the sender device may divide the file into a plurality of units and sequentially send the units to recipient device. The recipient device may compose the unit sequentially received into one file, store it to a memory and notify the recipient of the receiving of the file. According to an embodiment of the present disclosure, the sender device may collect various data. For example, the sender device may acquire images using a camera, and surrounding information and biometrics using sensors. Upon completion of the collection, the sender device may send to the recipient device an e-mail including the collected data.

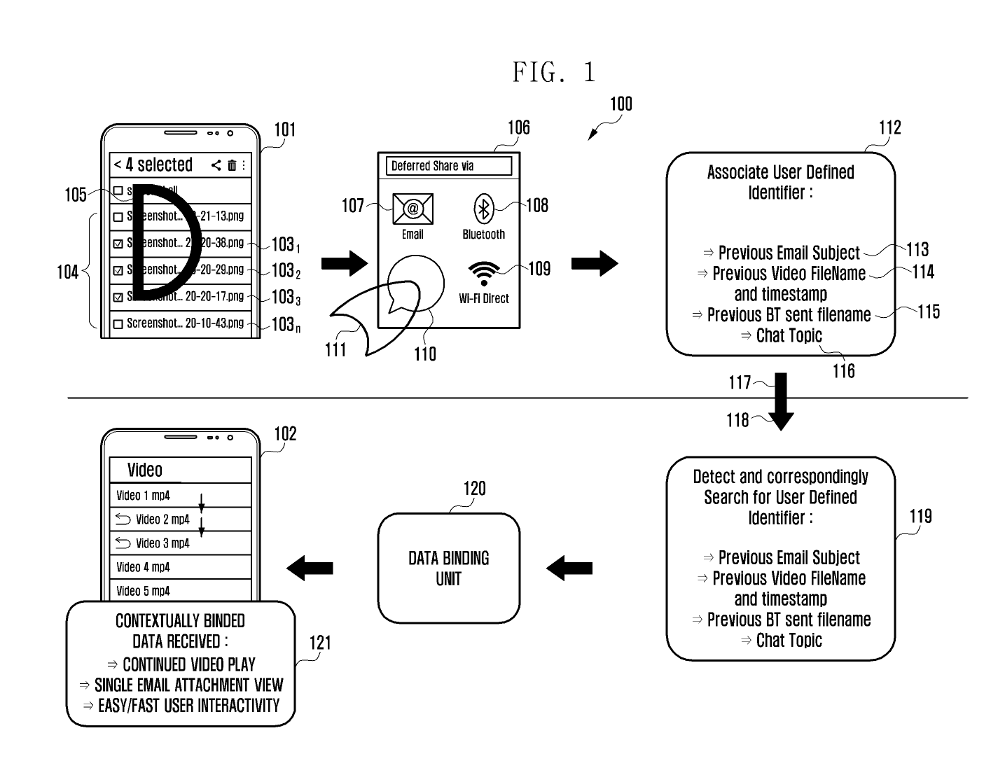

FIG. 1 illustrates a schematic flow diagram of a deferred data communication method between a sender device and a recipient device according to an embodiment of the present disclosure.

Referring to FIG. 1, there is illustrated a schematic flow diagram of a deferred data communication method (100) between a sender device (101) and a recipient device (102). In the illustrated example, the sender device can initially provide (i.e., render and display) a set of selectable data units (103ₗ to 103ₙ) and the method may comprise receiving selection (104) of one or more data units, for example, via a display (i.e., a touchscreen). The sender device may further receive an indication (105) that the selected one or more data units are to be transmitted using a deferred transmission method. In the example, the indication of the deferred transmission method may be identified as a touch input in the form of “D” character or an air-gesture input in the form of “D” character. In response to receiving the indication pertaining to the deferred transmission, a graphical user interface (GUI) (106) containing details of one or more communication modes as supported by the sender device may be provided. In the example, the GUI (106) may include information relating e-mail mode of communication (107), Bluetooth (BT) mode of communication (108), Wi-Fi Direct mode of communication (109) and instant messaging mode of communication (110). The sender device may receive a selection (111) of any one of the supported communication mode for transmission of the selected one or more data units. Based on the communication mode thus selected, the sender device may further receive details of a previous communication with the recipient from within the selected communication mode. Once the details of the previous communication with the recipient has been received by the sender device, the details may be used by the sender device for associating (112) an identifier related to the previous communication to the selected one or more data units. By way of example, in case the communication mode is chosen as e-mail, the identifier (113) can be received as at least a portion of data previously transmitted such as, the name of a sender, at least a part of a user's comment in an email, an address of the email, a sending time, or the name of attached files. According to various embodiments of present disclosure, the sender may use a unique identifier (UID) to associate it with a data unit. In other words, the identifier may be a common ID (e.g., an email address) for a user to recognize that data units are related. For example, if a sending time of first data is different from a sending time of second data, each of the first data and second data may be uniquely identified by the UID such as a combination of an e-mail address and a sending time. If the communication mode is chosen as Wi-Fi Direct, the identifier can be received in the form of a previous video file name and time stamp (114). If the communication mode is chosen as BT, the identifier can be received in the form of previous BT sent file name (115). If the communication mode is chosen as instant messaging, the identifier can be received in the form of chat topic (116). The sender device (101) may send (117) the selected one or more data units along with the identifier to the recipient.

The recipient device (102) may receive (118) the one or more data unit sent in the form of a deferred data unit. The recipient device may detect the identifier as contained in the one or more data units thus received and search through the communication mode, as specified by the identifier, for the previous communication matching with the identifier (119). Once the previous communication matching with the identifier has been identified, the recipient device may store (120) the one or more data units in association with the identified previous communication. As and when there is a request for rendering, the one or more data units along with the previous communication may be fetched and rendered together (121).

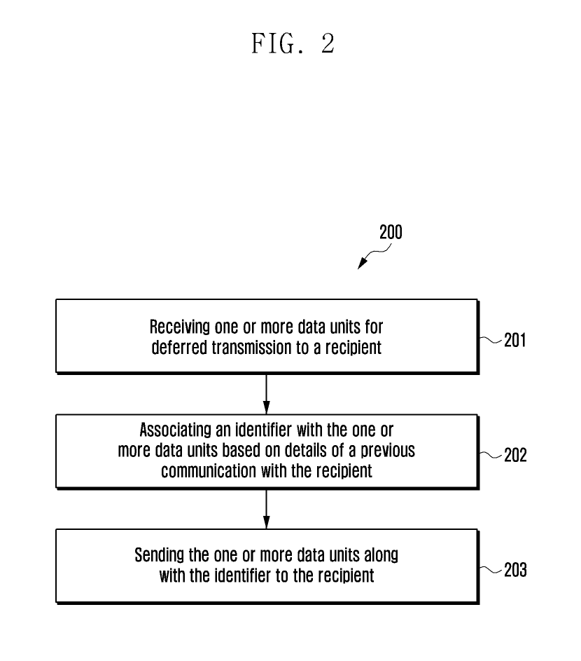

FIG. 2 illustrates a flowchart of a method of deferred data transmission according to an embodiment of the present disclosure.

Referring to FIG. 2, there is illustrated a flowchart of a method of deferred data transmission (200) corresponding to an embodiment of the disclosure. The deferred data transmission method (200) comprises receiving at operation 201 one or more data units for deferred transmission to a recipient. In response to such receiving, an identifier may be associated at operation 202 with the one or more data units based on details of a previous communication with the recipient. The method may further include sending at operation 203 the one or more data units along with the identifier thus associated thereto to the recipient.

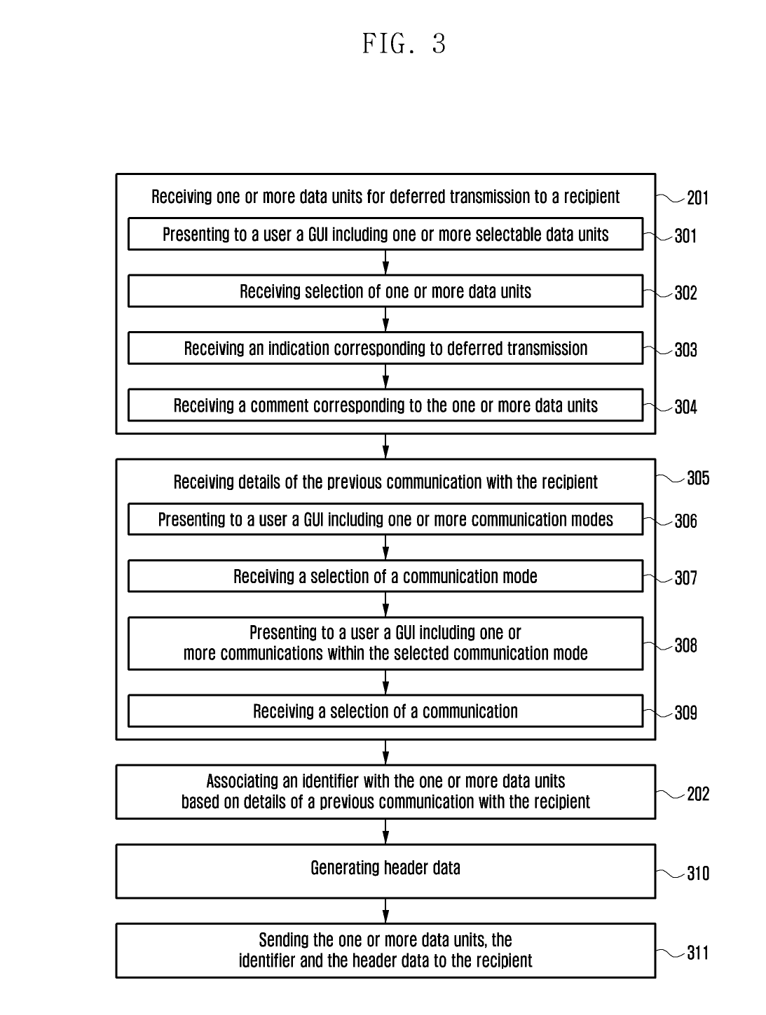

The method as illustrated in FIG. 2 can be supplemented with additional operations as illustrated in FIG. 3.

FIG. 3 illustrates a flowchart of a method of deferred data transmission according to an embodiment of the present disclosure.

Referring to FIG. 3, in one aspect, the operation of receiving one or more data units for deferred transmission to a recipient i.e. operation 201 of FIG. 2 can further comprise presenting at operation 301 to a user a GUI including one or more selectable data units and receiving at operation 302 a selection of one or more data units from said one or more selectable data units.

In another aspect of the present disclosure, along with receiving the one or more data units for deferred transmission, the method may further include receiving at operation 303 an indication corresponding to deferred data transmission, wherein the indication can be in the form of a gesture, a touch or a voice, etc. In an alternative embodiment, the indication corresponding to deferred transmission can be received separately instead of being received during the operation of receiving the one or more data units.

In another aspect of the present disclosure, along with receiving the one or more data units for deferred transmission, the method may further include receiving at operation 304 a comment corresponding to the one or more data units. In an alternative embodiment, the operation of receiving comments is separate and can either precede the operation of receiving the one or more data units or follow the operation of receiving the one or more data units.

Since the deferred data transmission pertains to a first communication which previously happened with the recipient, the deferred transmission method may further comprise receiving at operation 305 details of the first communication with the recipient. If the deferred transmission pertains to a first communication which previously happened, the same may not be currently active at the time of sending the one or more data units for deferred transmission to the recipient.

Without wishing to be restricted, in one embodiment, the details of the first communication with the recipient can be received by presenting at operation 306 to a user a GUI including one or more communication modes and receiving at operation 307 a selection of a communication mode through the GUI. After the selection of the communication mode is received, the system may present at operation 308 to the user a GUI including one or more communication as done within communication mode and receive at operation 309 a selection of a previous communication as done with the recipient from within the communication mode.

In case the user is already within the communication mode (for example, if the user is already operating the e-mail), the operations 306 and 307 can be avoided and the remaining operations i.e. operations 308 and 309 may be performed.

In an embodiment of the present disclosure, the method may further comprise generating at operation 310 header data. In a preferred aspect, the header data can be either of a first type or a second type. The first type may indicate that the one or more data units being transmitted includes a link to a previous communication. The second type may indicate that the one or more data units being transmitted does not have any link to a previous communication. The header data can be beneficially used by the receiving device (102). In one embodiment, the header data can be used by the receiving device for quickly identifying that the one or more data units thus transmitted pertain to a deferred transmission. This provides a time saving at the receiving device. Yet another advantage could be resource saving at the receiving device. Thus, in case the header data as described above is generated, the operation of sending 311 now sends the one or more data units, the identifier and the header data to the recipient.

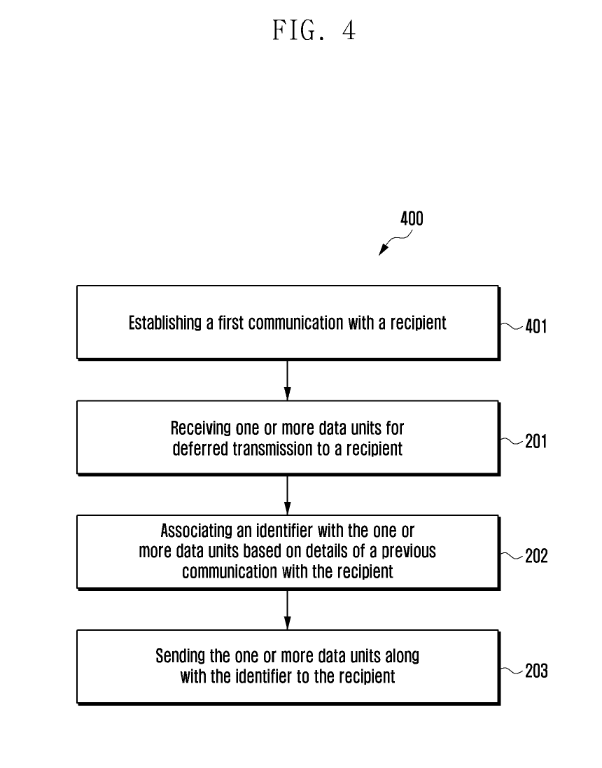

FIG. 4 illustrates a deferred transmission method corresponding to a previous communication according to an embodiment of the present disclosure.

Referring to FIG. 4, the method (400) may comprise establishing at operation 401 a first communication with a recipient. The establishing at operation 401 may be then followed by the operations of receiving at operation 201 one or more data units for deferred transmission to the recipient, associating at operation 202 an identifier to the one or more data units based on details of the first communication with the recipient, and sending at operation 203 the one or more data units along with the identifier thus associated thereto to the recipient, as illustrated in FIG. 2.

In the following paragraphs, different implementations of the deferred transmission method are described along with reference to the corresponding figures. The different implementations being described herein after are merely for illustration purposes and the same should not be construed to limit the scope of the claims in any manner

One of the most common ways to share attachments may be by using an e-mail communication mode.

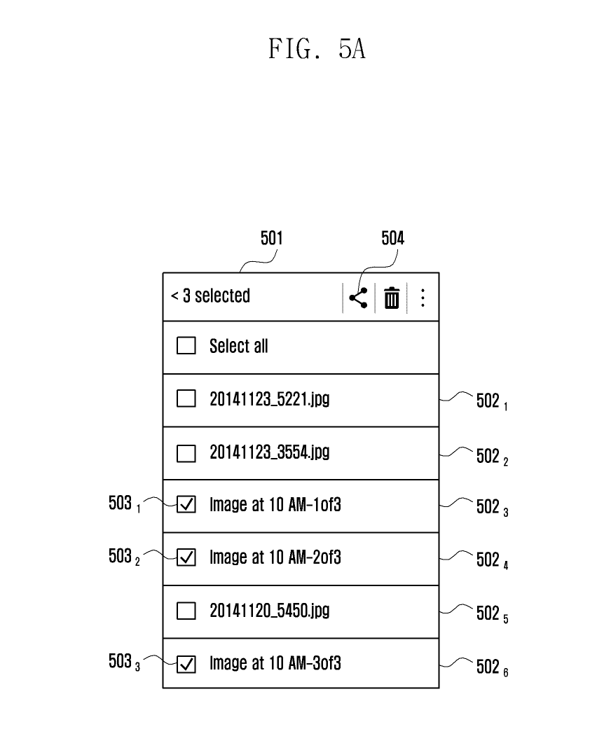

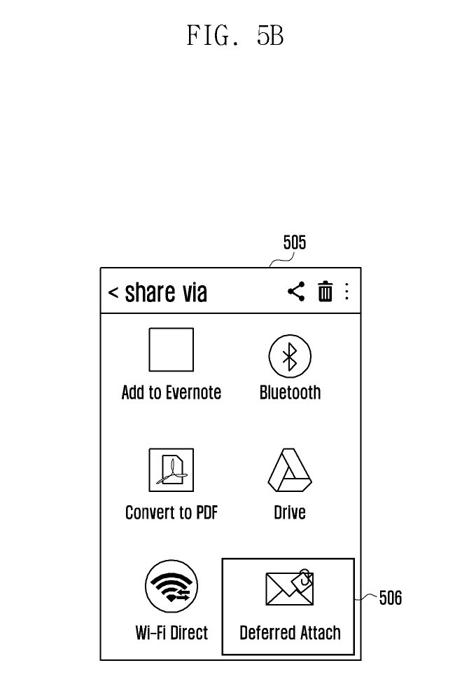

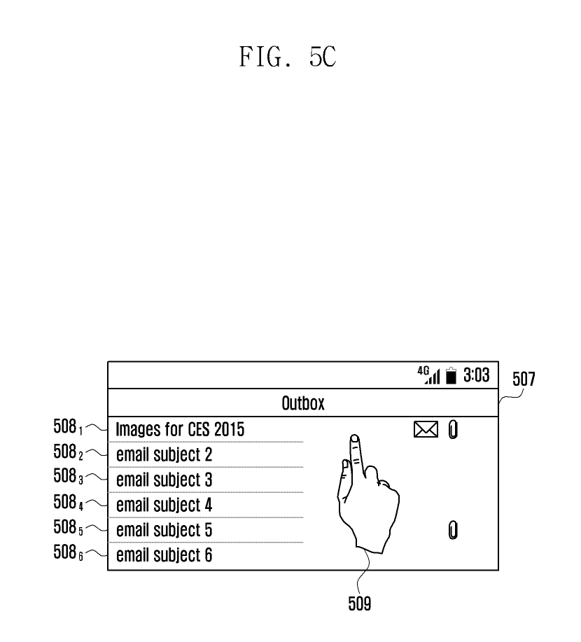

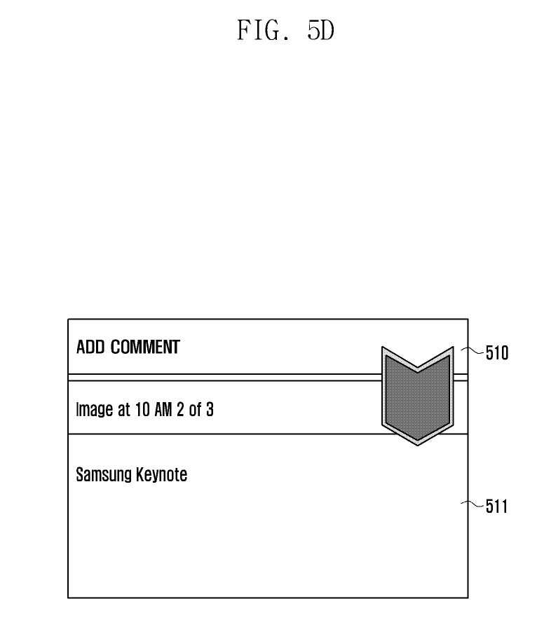

FIGS. 5A to 5D illustrate a schematic flow diagram of a method of deferred data transmission via an e-mail system according to an embodiment of the present disclosure.

Referring to FIGS. 5A to 5D, there is illustrated one embodiment by which attachments can be sent via the deferred transmission method. For example, as shown in FIG. 5A, the user can go to a library (501) which for example contains multiple digital contents (502₁, 502₂, 502₃, 502₄, 502₅ and 502₆). The user can select one or more of the digital contents from the library (503₁, 503₂ and 503₃). Thereafter, the user can select the “option” icon (504). Referring to FIG. 5B, in response to selection of the option icon, a plurality of options may be presented to the user via a GUI (505). One of the presented options may include “deferred attach” (506). In response to detecting selection of the deferred attach option, the user may be directed to outbox (507) of an email communication mode as illustrated in FIG. 5C. The outbox (507) can render one or more communications (508₁, 508₂, 508₃, 508₄, 508₅ and 508₆) which have already happened and the user can select (509) any of the communications. In response to receiving a selection of a particular communication, the digital contents previously selected (503₁, 503₂ and 503₃) may be sent as deferred attachments to the selected communication. It is feasible that the user may wish to add some specific comment to the attachments and to cater to the same. In that case, a GUI (510) for allowing the user to add a comment as shown in FIG. 5D can be presented. Using the GUI (501), the user can provide comments (511) which will be sent along with the attachments.

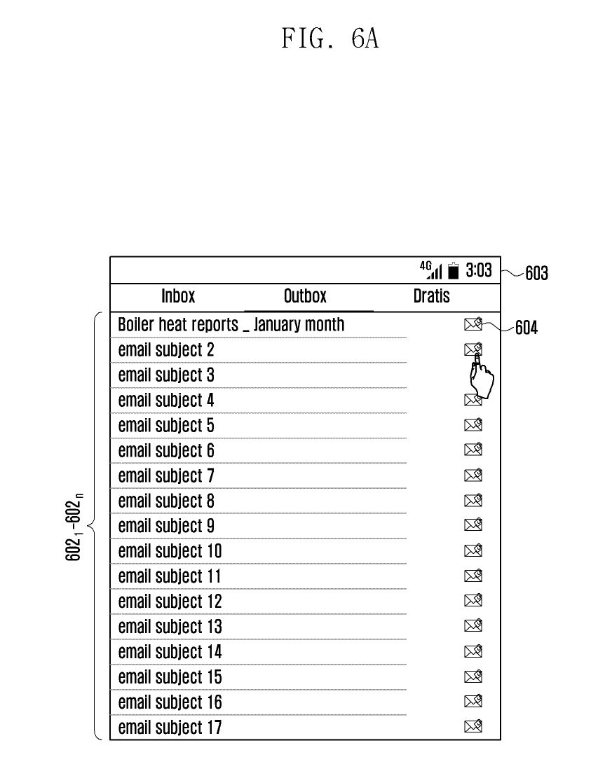

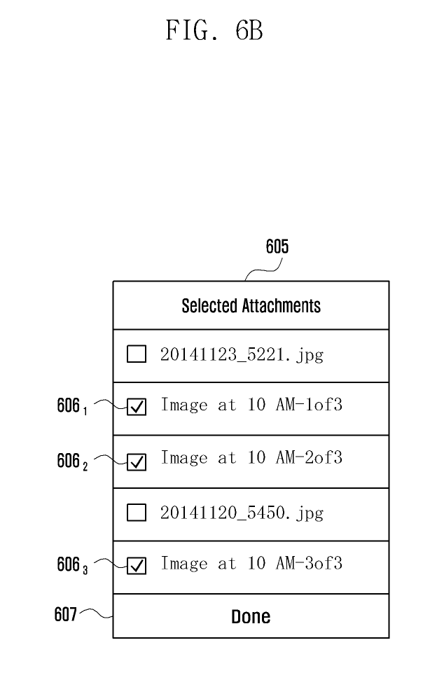

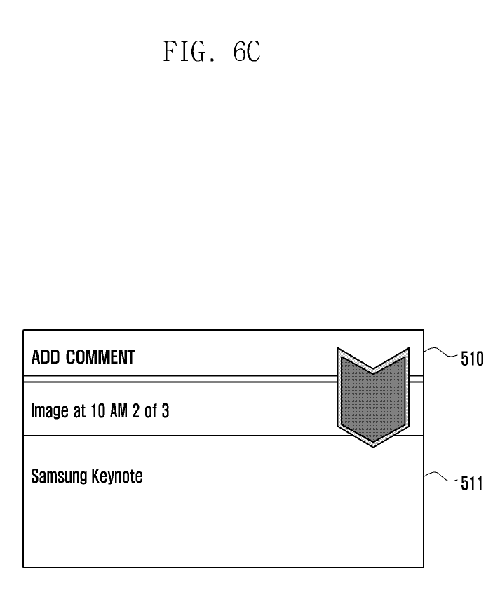

FIGS. 6A to 6C illustrate a schematic flow diagram of a method of deferred data transmission via an e-mail system according to an embodiment of the present disclosure.

Referring to FIGS. 6A to 6C, there is illustrated another embodiment by which attachments can be sent via the deferred transmission method. For example, as shown in FIG. 6A, the user can view the outbox 601 of the e-mail communication mode which renders one or more past communications sent (602ₗ to 602ₙ). In an embodiment, in respect of each sent communication, there can be presented a small icon (603), which upon actuating (604) will enable the user to select one or more attachments for sending using the deferred transmission method. For example, as shown in FIG. 6B, upon detecting actuation (604), a GUI (605) will be presented. Through the GUI (605), the user can select one or more attachments (606₁,606₂ and 606₃). Completion of the selection can be detected based on selection of the “Done” icon (607). Similarly to FIG. 5D, FIG. 6C illustrates a GUI (510) for allowing the user to add comment (511). The digital contents previously selected (606₁, 606₂ and 606₃) may be sent as deferred attachments to said selected communication.

According to any of the above described method of deferred transmission, the e-mailing systems can be divided in two broad categories of Deferment aware systems, and Deferment non-aware systems.

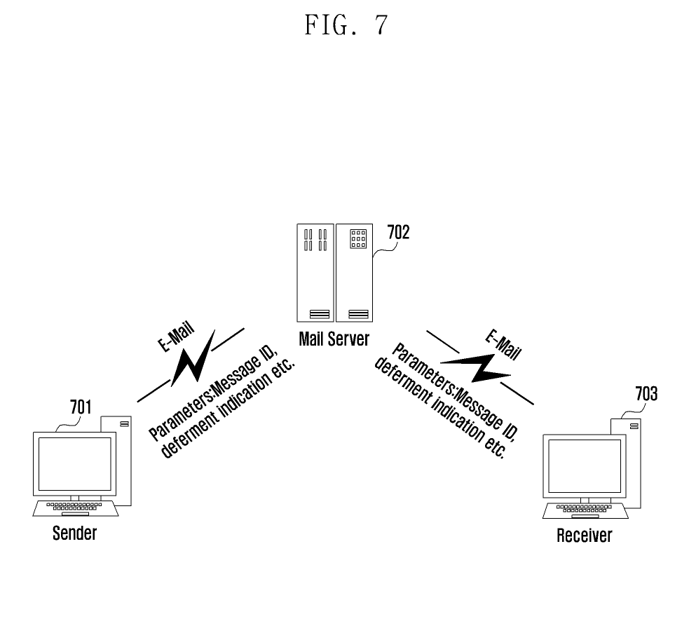

An example of a Deferment aware system is an e-mail system which is aware of the deferred attachment emailing. Such an email system supports deferred attachments natively and can also provide an option for a user to mark an email as a deferred attachment type before sending out the email. A block diagram of a deferment aware email system is illustrated in FIG. 7.

FIG. 7 illustrates a schematic flow diagram of a method of deferred data communication in a deferment aware e-mail system according to an embodiment of the present disclosure.

Referring to FIG. 7, a sender device (701) passes on the information about deferment to the server (702) at the time of sending out the email. In such case, the information about deferment is passed onto the receiver (703) by the mail server.

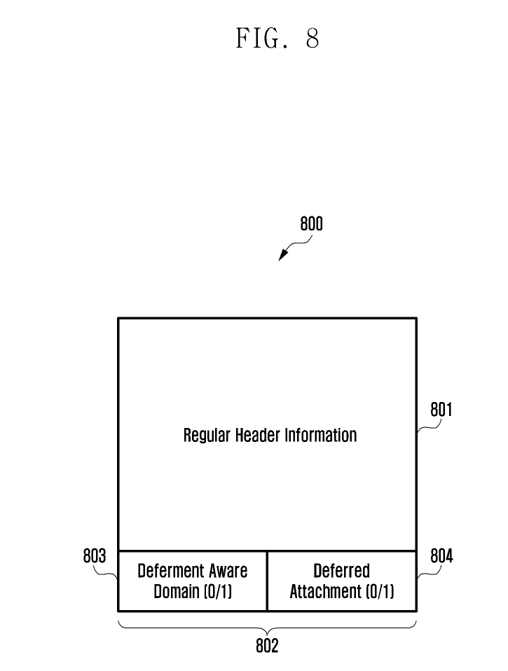

An e-mail system can be operated as a deferment aware system, by including a deferment indication in the outgoing e-mail. In an embodiment of the present disclosure, the deferment indication which is communicated in deferment aware systems can be sent as a part of the email header. A format of a header which may be adopted to make a communication system a deferment aware system is shown in FIG. 8.

FIG. 8 illustrates a format of a header which may be adopted to make a communication system a deferment aware system according to an embodiment of the present disclosure.

Referring to FIG. 8, a header (800) comprises regular header information (801) and a deferment indication (802). In an embodiment of the present disclosure, the deferment indication (802) can be adopted to carry information about two aspects, namely a deferment aware domain (803) and a deferred attachment (804). Information about the deferment aware domain (803) can be present in the form of one bit and likewise, information about the deferred attachment (804) can be present in the form of one bit. Thus, compared to a normal header, the header (800) as shown in FIG. 8 may further comprise two additional bits.

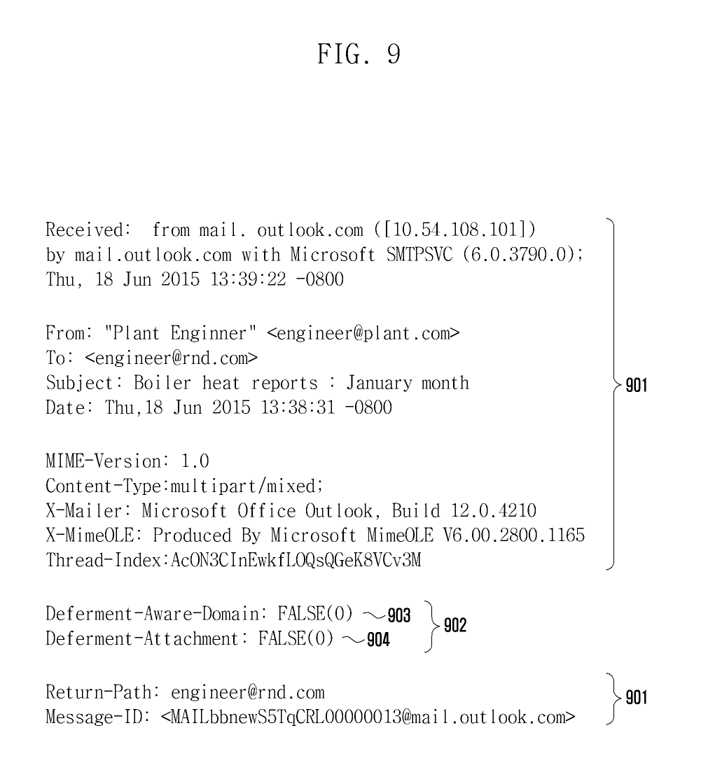

FIG. 9 illustrates a detailed view of an e-mail header as may be adopted in a deferment aware e-mail system according to an embodiment of the present disclosure.

Referring to FIG. 9, an email header may include regular header information (901) and a deferment indication (902), which is adapted to carry information in relation to a deferment aware domain (903) and a deferred attachment (904).

Information in relation to a deferment aware domain may include a bit that indicates whether the sending email domain supports the deferred attachment mechanism. If the support is present, the bit may be set to 1 i.e. TRUE, and if the support is not present, the bit may be set to 0 i.e. FALSE.

Information in relation to a deferred attachment may include a bit that indicates whether the email is carrying any deferred attachment. If a deferred attachment is present in the email, the bit may be set to 1 i.e. TRUE, else it may be set to 0, i.e. FALSE.

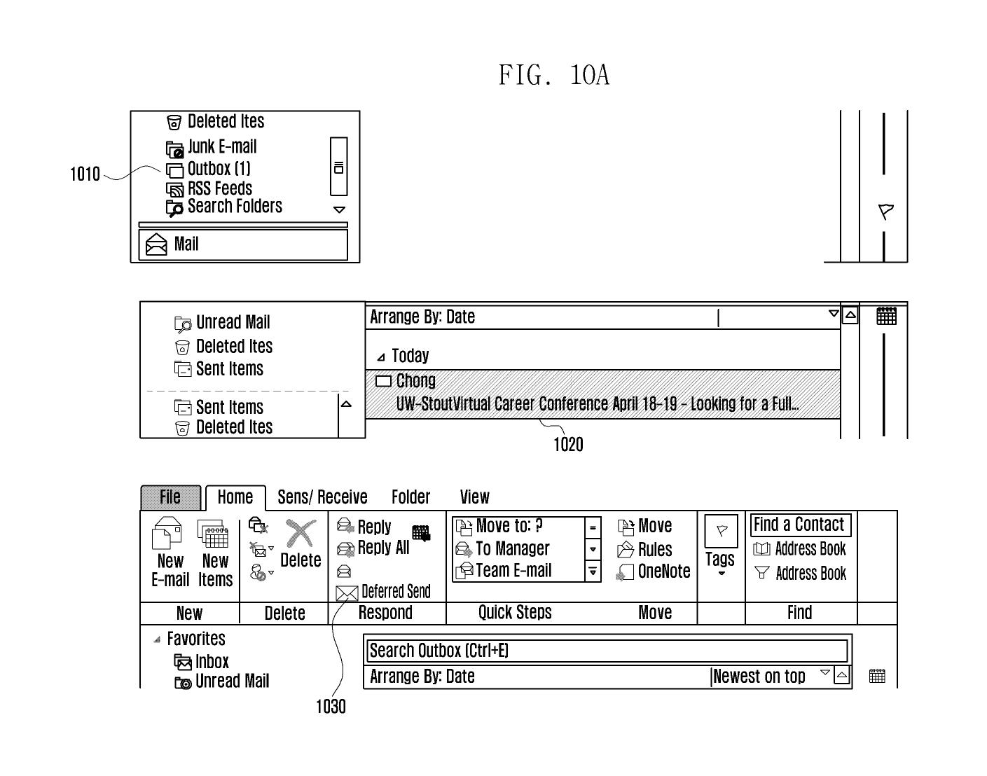

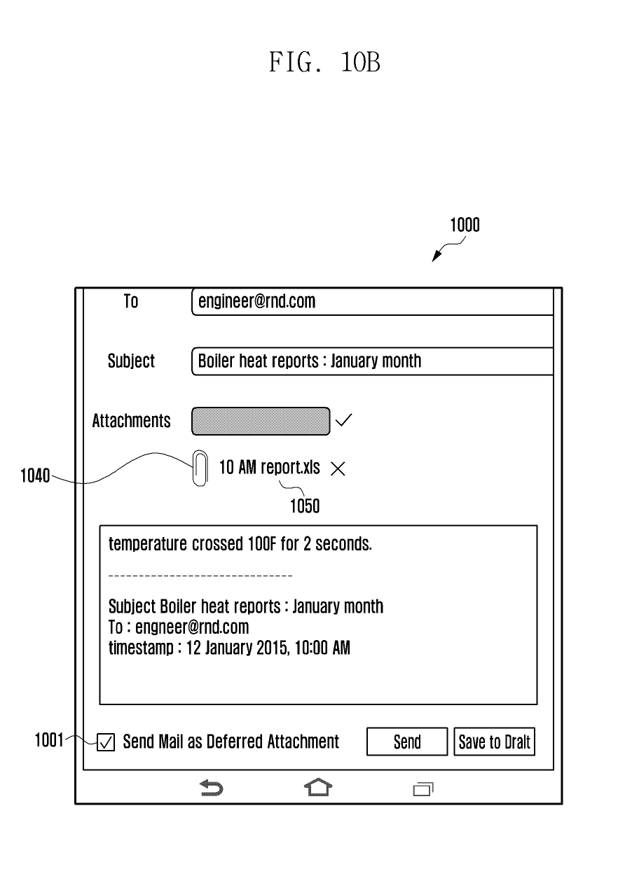

FIGS. 10A and 10B illustrate a method for marking an email as carrying a deferred attachment according to an embodiment of the present disclosure.

Referring to FIG. 10A, a deferment aware system may detect selection of an icon 1010 of an outbox in a displayed email browser. In response to detecting the selection of the icon 1010, the deferment aware system may display the outbox. Thereafter, the system may detect selection of an email 1020 sent previously (e.g., today) and selection of a deferred transmission option 1030. And, in response thereof, display, as shown in FIG. 10B, a UI control 1000 for carrying a deferred attachment to a recipient of the selected email. The user can attach a file as a deferred attachment into the selected email. For example, an adding icon 1040 may be displayed on UI control 1000. Upon selecting the icon 1040, a file list can be displayed and a selected file 1050 may be attached to the selected email. The deferment aware system may provide an easy method for users to mark the email as carrying a deferred attachment. As illustrated in FIG. 10B, each user replying to the communication shall be shown a UI control (1000) to mark (1001) the email as deferred attachment type. Another advantage of such a system could be the fact that the user will be shown error controlling checks in order to further enhance and extend the system.

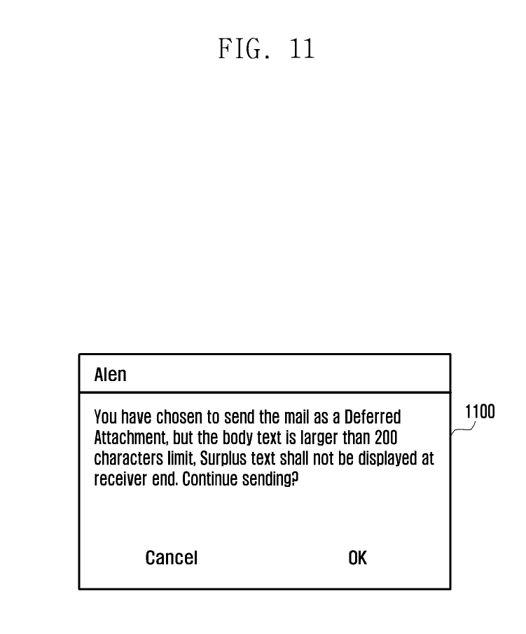

FIG. 11 illustrates a pop-up which may notify the user about an error according to an embodiment of the present disclosure.

Referring to FIG. 11, a system may have a limitation for text comment in a deferred email to be of 200 characters only. The user can be shown a pop-up (1100) when the email's new content is greater than 200 characters.

It may be noted that the deferred attachment can be sent using any e-mail system (i.e. deferment non-aware system).

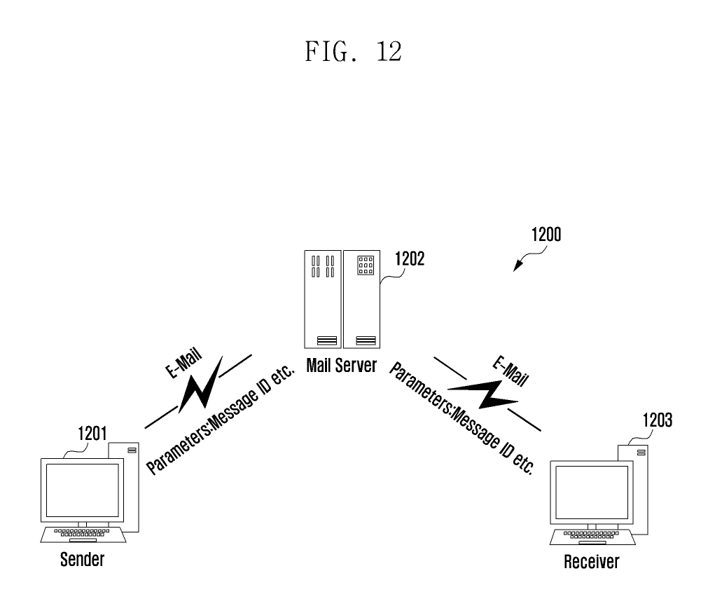

An example of a deferment non-aware system is a traditional e-mail system which has no information about deferred attachments. A block diagram of a deferment non-aware email system is illustrated in FIG. 12.

FIG. 12 illustrates a schematic flow diagram of a method of deferred data communication in a deferment non-aware e-mail system according to an embodiment of the present disclosure.

Referring to FIG. 12, in a deferment non-aware e-mailing system, a sender device (1201) does not have the capability to explicitly mark an email as containing a deferred attachment before sending the same to a server (1202). As a result, no such information is passed onto a receiver (1203) by the mail server.

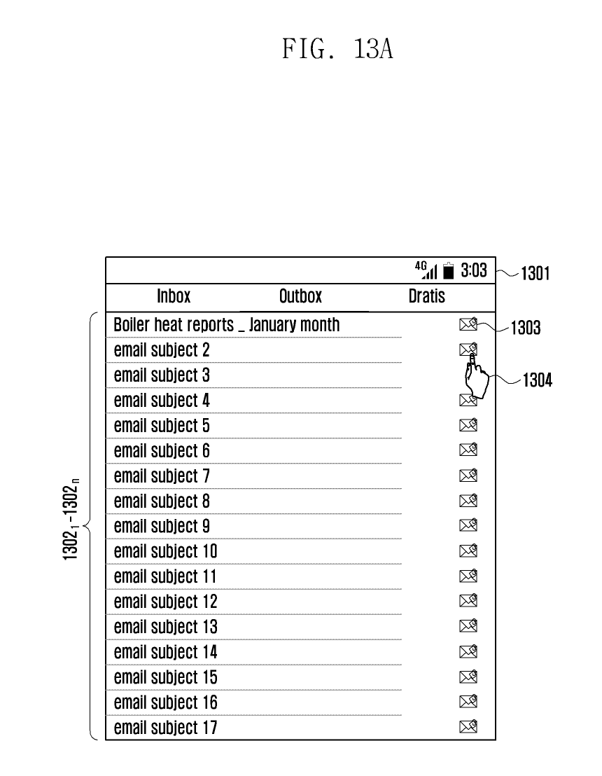

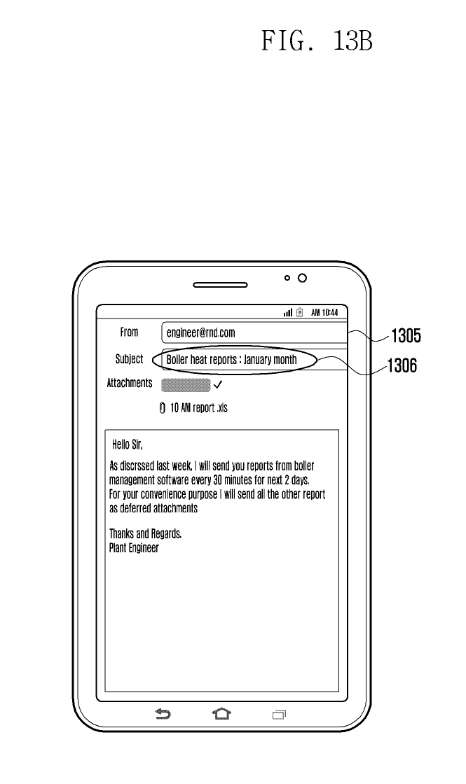

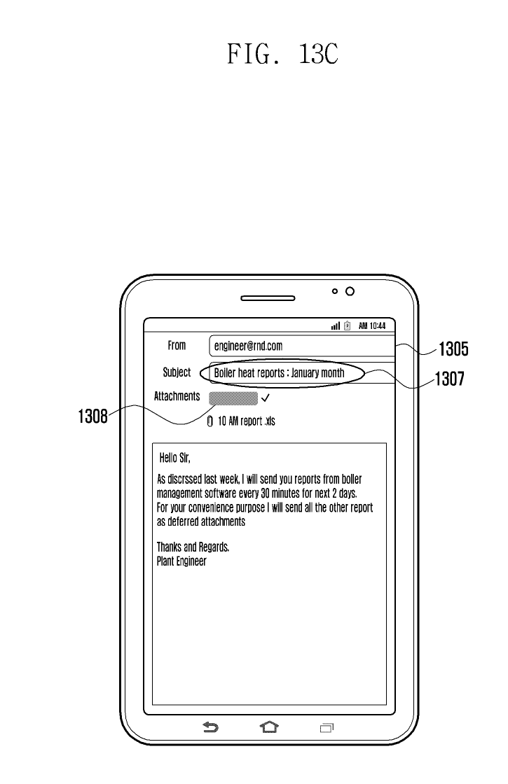

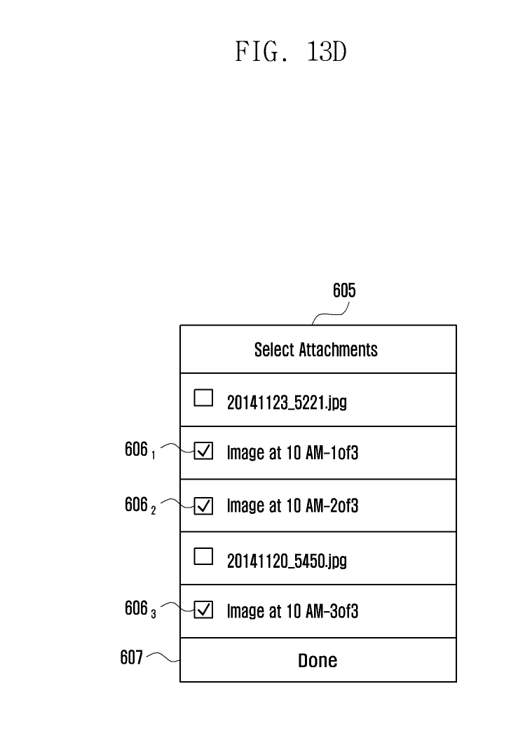

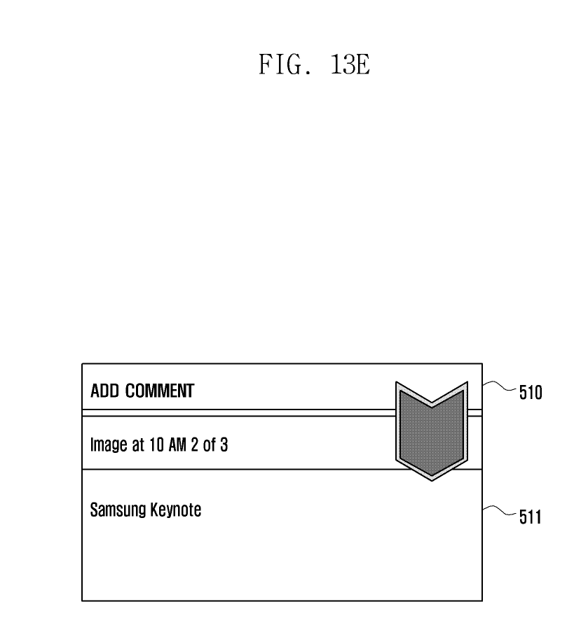

To provide backward compatibility with deferment non-aware systems, a different method may be adopted, an example of which is illustrated in FIGS. 13A to 13E and explained below.

FIGS. 13A to 13E illustrate a schematic flow diagram of a method of deferred data transmission via a deferment non-aware e-mail system according to an embodiment of the present disclosure.

Referring to FIGS. 13A to 13E, there is illustrated an embodiment by which attachments can be sent via deferment non-aware systems. For example, as shown in FIG. 13A, the user is already viewing an outbox (1301) in an e-mail communication mode which renders one or more past communications sent (1302ₗ to 1302ₙ). In an embodiment, in respect of each sent communication, there can be presented a “reply all” icon (1303), which upon actuating (1304) will create a fresh e-mail (1305), as illustrated in FIG. 13B. It may be noticed that the subject matter of the fresh e-mail starts with “Re: . . . ” as indicated by 1306 in FIG. 13B. The user may amend this and replace the “Re: . . . ” by “[attach]. . . ” as shown by 1307 in FIG. 13C. Thereafter, the user can attach one or more attachments using the “attachment” option (1308) as shown in FIG. 13D (which is substantially similar to FIG. 6C and hence, not described in detail), optionally add comments to the attachment, as shown in FIG. 13E (which is substantially similar to FIG. 6C and hence, not described in detail) and send the same. In the illustrated embodiment, based on the syntax of the subject i.e. the prefix “[attach]” the receiver can invoke special handling and more particularly identify and handle the received e-mail as containing deferred attachment type.

While in the above paragraphs, a few methods of implementing a deferred transmission method in an e-mail communication system have been described with reference to FIGS. 5A to 5D, 6A to 6C, 7, 8, 9, 10A and 10B, 11, 12, and 13A to 13E, the implementation details as provided above should not be construed as limiting the scope of the present disclosure.

In the recent years, sharing of attachments using instant messaging systems has become prevalent and hence, in the following paragraphs, a few methods of implementing the deferred transmission method in an instant messaging system are being described.

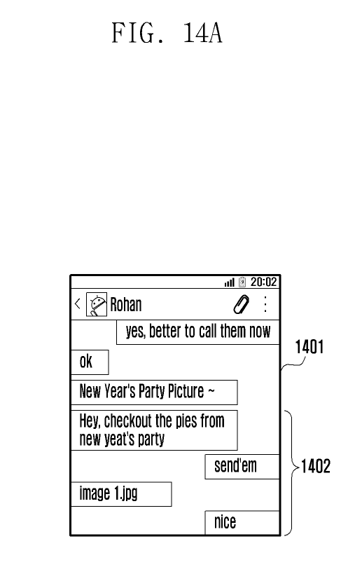

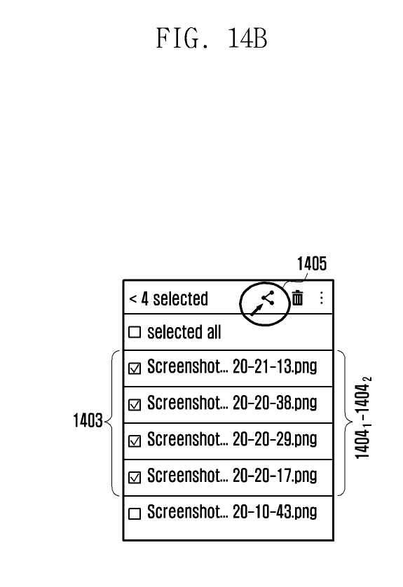

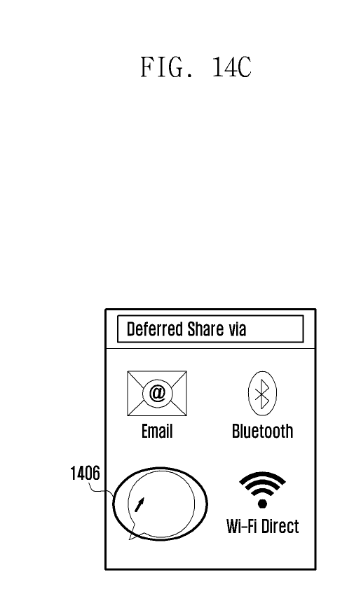

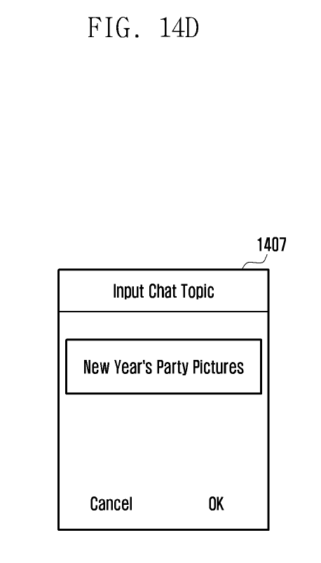

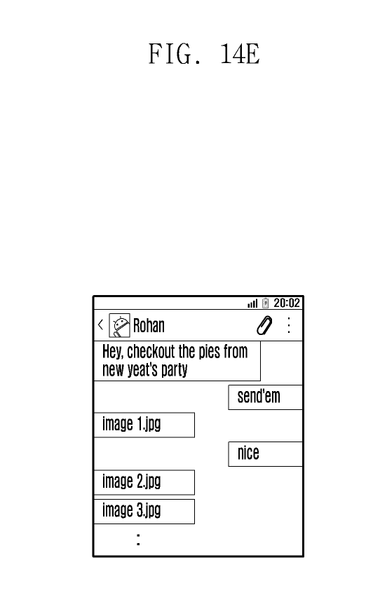

FIGS. 14A to 14E illustrate a schematic flow diagram of a method of deferred data transmission via an instant messaging system according to an embodiment of the present disclosure.

Referring to FIGS. 14A to 14E, there is illustrated an embodiment for sharing deferred attachments via an instant messaging system. As illustrated in FIG. 14A, a sender may provide a topic (1401) and establish communication (1402) with a recipient. Thereafter, the sender may send one or more further attachments to the recipient in the form of deferred attachments, as he can now select (1403) the attachments (1404₁-1404₄) as illustrated in FIG. 14B. Thereafter, the user may select (1405) an option pertaining to “deferred sharing”. As illustrated in FIG. 14C, from the various options which may be presented, the user may now select (1406) the instant messaging option. As illustrated in FIG. 14D, a GUI (1407) may be presented for seeking a chat topic from the user. The chat topic may indicate the relative contents of the deferred directory. The topic may be included within the instant messaging (IM) session by sending a special message. The IM session may indicate that subsequent messages being sent by the sender will now be part of this topic. This special message may be initiated by either the sender or receiver. The special message may be interpreted by the instant messaging Server, and the topic may be rendered in the GUI for easy user viewing. In an alternative, instead of seeking the chat topic from the user, the chat topic can be auto-generated (based on context parsing). In the alternative option, the GUI may be presented for seeking the details of the recipient or any other information based on which the past communication can be identified. Once the past communication has been identified, as illustrated in FIG. 14E, the selected attachments may be sent in the form of deferred attachments.

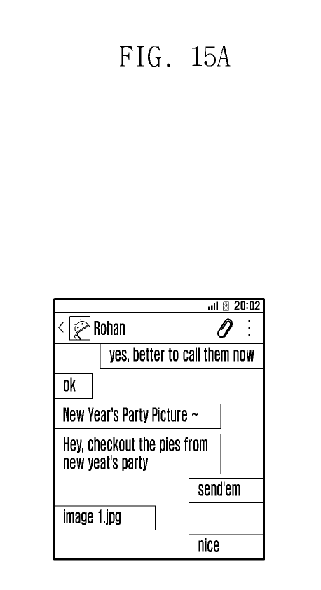

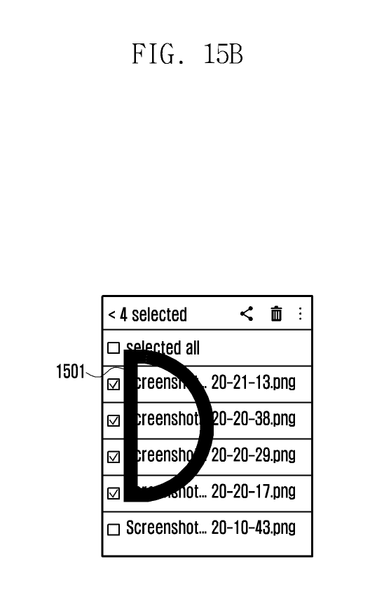

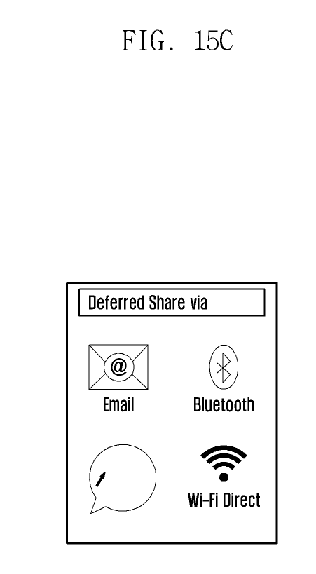

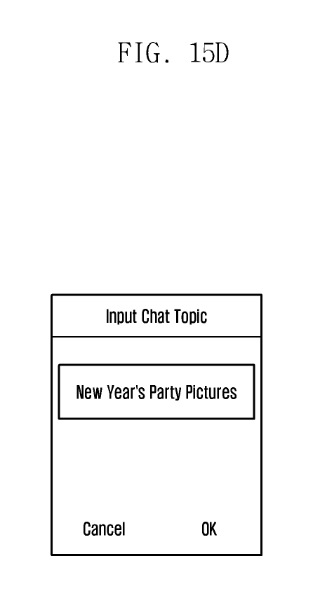

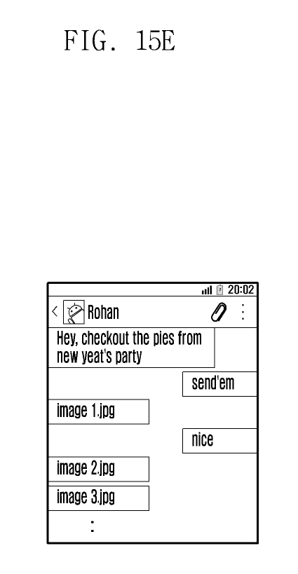

FIGS. 15A to 15E illustrate a schematic flow diagram of a method of deferred data transmission via an instant messaging system according to an embodiment of the present disclosure.

Referring to FIGS. 15A to 15E, there is illustrated another embodiment for sharing deferred attachments via an instant messaging system. The method illustrated in FIGS. 15A to 15E is substantially similar to that in FIGS. 14A to 14E except for FIG. 14B. In light of the above, the features that are common to FIGS. 14A to 14E and 15A to 15E are not being explained and reference may be made to the description as provided above with respect to FIGS. 14A to 14E for the same. As illustrated in FIG. 15B, the selection (1501) pertaining to “deferred sharing” may be received in the form of a pattern input in the form of “D”. It may however be noted that any other pattern can be configured either in the form of factory setting or in the form of user setting. In yet another alternative which is not illustrated, the selection pertaining to “deferred sharing” may be received in the form of over-the-air gesture.

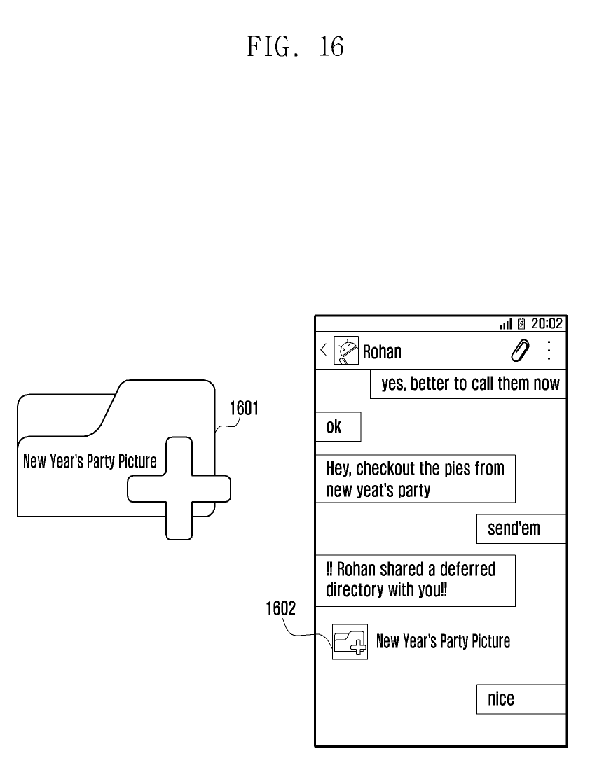

FIG. 16 illustrates a schematic flow diagram of a method of deferred directory transmission via an instant messaging system according to an embodiment of the present disclosure.

Referring to FIG. 16, there is illustrated yet another embodiment for sharing deferred attachments via an instant messaging system. In this embodiment, the sender device may initially create a first “deferred directory” (1601) and then send (1602) information related to the first deferred directory via the instant messaging system to the recipient device. The recipient device may create a second “deferred directory” (1602) based on the received information and display in a message window the second deferred directory. When adopting this embodiment, subsequent to the sharing of the deferred directory, content (e.g., an image) may be added to the first deferred directory. If so, the content along with an identifier thereof (e.g., directory information) may be sent to the recipient device. The recipient device may associate the content with the second deferred directory and store it in a memory. The sending of a deferred directory is implemented using the methods of the related art for sharing a folder within a chat session.

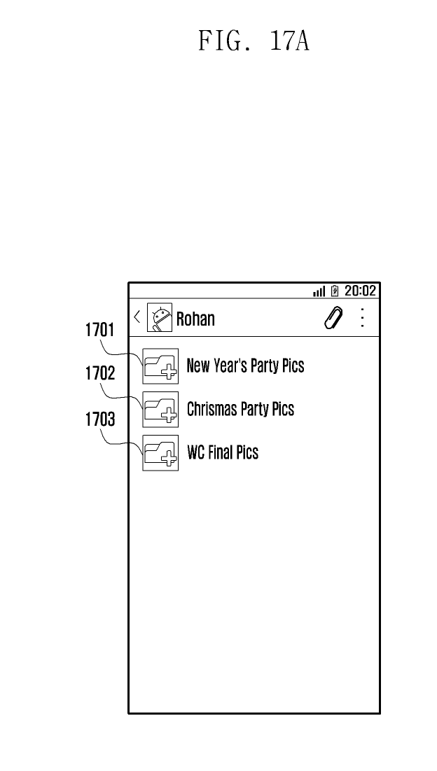

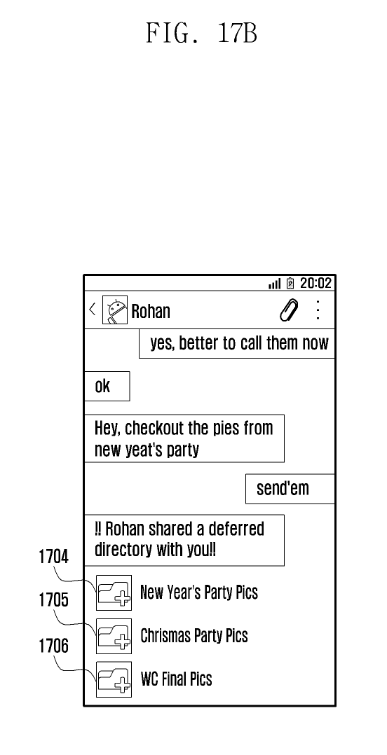

FIGS. 17A and 17B illustrate a schematic flow diagram of a method of deferred transmission of multiple directories via an instant messaging system according to an embodiment of the present disclosure.

Referring to FIGS. 17A and 17B, it is feasible to send multiple deferred directories. In this regard, as illustrated in FIG. 17A, the user can create a first deferred directory (1701), a second deferred directory (1702) and a third deferred directory (1703) and then send (1704) the first deferred directory (1701), send (1705) the second deferred directory (1702), and send (1706) the third deferred directory (1703) via the instant messaging system as illustrated in FIG. 17B. When adopting this embodiment, the user can add new content subsequent to sharing of each of the first, second and the third deferred directory.

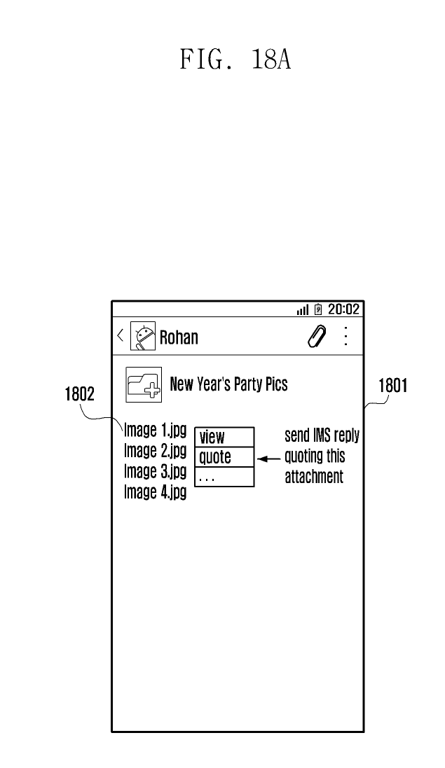

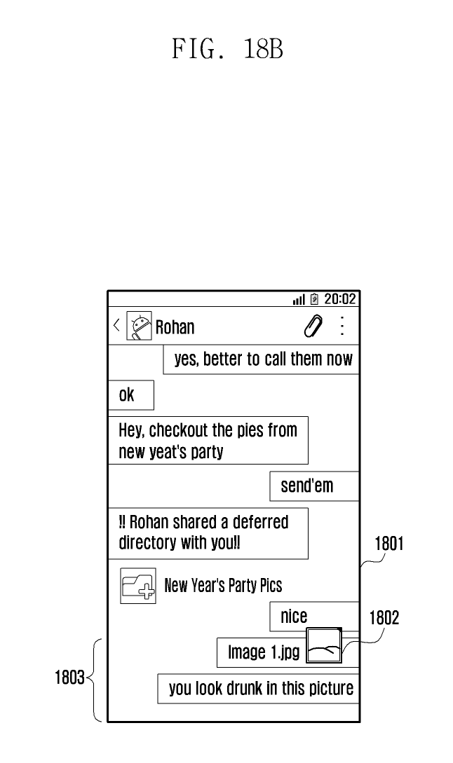

FIGS. 18A and 18B illustrate a schematic flow diagram of adding comments to data under deferred transmission and transmission of the same according to an embodiment of the present disclosure.

Referring to FIGS. 18A and 18B, it is feasible to add a comment (1801) to the attachment (1802) which is being sent as a deferred transmission as illustrated in FIG. 18A. Once the comment is added to the attachment, as illustrated in FIG. 18B, the comment (1801) can be automatically sent (1803) along with the deferred attachment (1802) via the instant messaging system.

While in the above paragraphs, a few methods of implementing a deferred transmission method in an instant messaging system have been described with reference to FIGS. 14A to 14E, 15A to 15E, 16A and 16B, 17A and 17B, and 18A and 18B, the method can be implemented by other alternative methods and the scope of the present disclosure is not limited to the implementation details as provided above.

It is also a common practice to share digital content using short range communication modes. Such short range communication modes include BT, Wi-Fi, near field communication (NFC), radio frequency identification (RFID), etc. Thus, in the following paragraphs, a few methods of implementing a deferred transmission method by adopting a short range communication mode will be described.

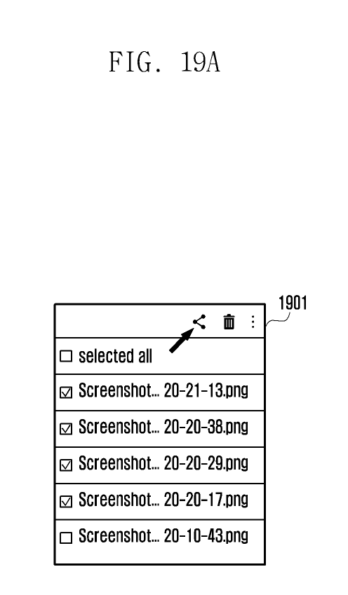

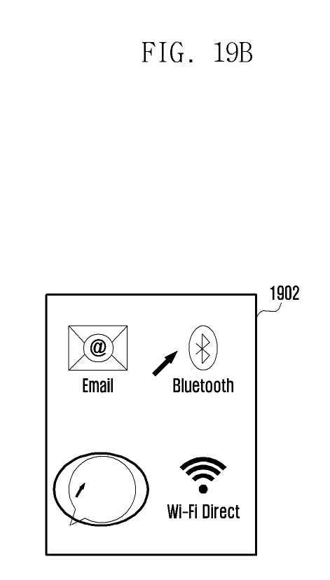

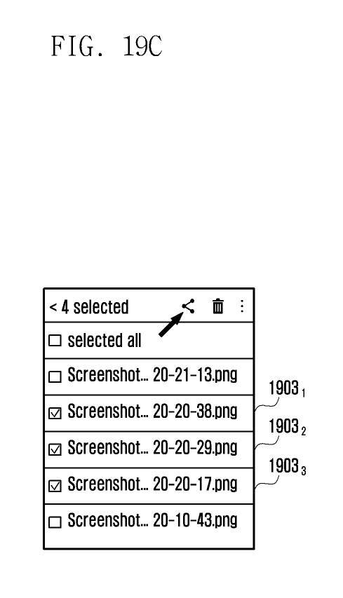

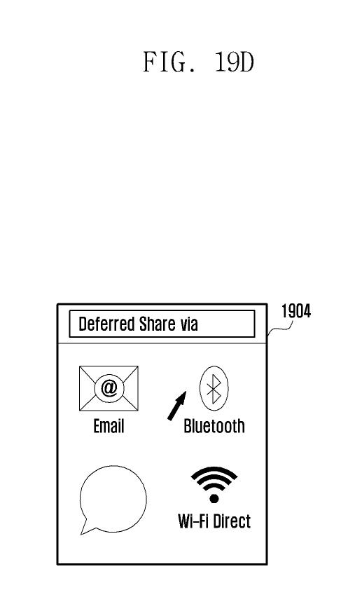

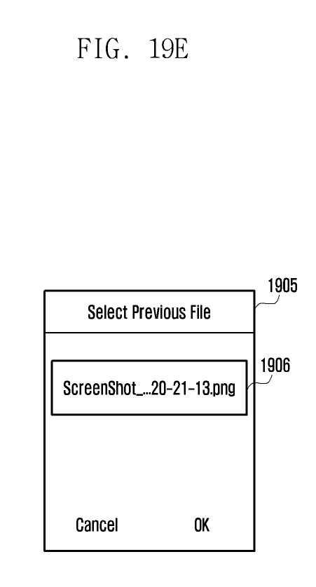

FIGS. 19A to 19E illustrate a schematic flow diagram of a method of deferred image transmission via a short range communication mode according to an embodiment of the present disclosure.

Referring to FIGS. 19A to 19E, there is illustrated an embodiment for sharing deferred attachments via an instant messaging system. As illustrated in FIG. 19A, a content selection (1901) may be received and as illustrated in FIG. 19B selection (1902) of a short range communication mode (BT in this case) may be received. Based on the above selections and further inputs as may be needed for transmission (which are not specifically illustrated), an initial communication may be sent to a recipient. In the initial communication, the selected content (1901) may be shared. Referring to FIG. 19C, at a later point in time one or more content selection (1903₁-1903₃) may be received and as illustrated in FIG. 19D a selection (1904) for deferred transmission along with selection of the short range communication mode (BT in this case) may be received. In response to the above, as illustrated in FIG. 19E, the user may be presented with a GUI (1905). The GUI may prompt the user to enter details of the file previously transferred (1906). In an alternative embodiment, the GUI may be presented for seeking the details of the recipient or any other information based on which the past communication can be identified. Once the past communication has been identified, the selected attachments may be sent in the form of deferred attachments.

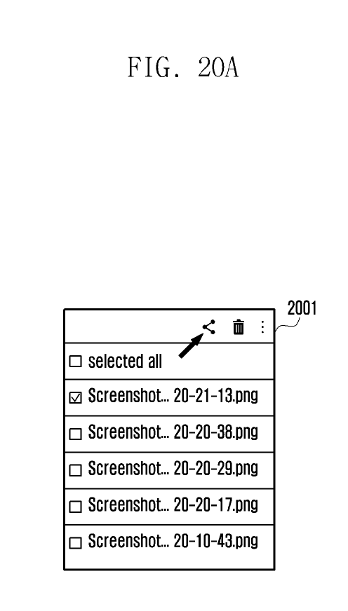

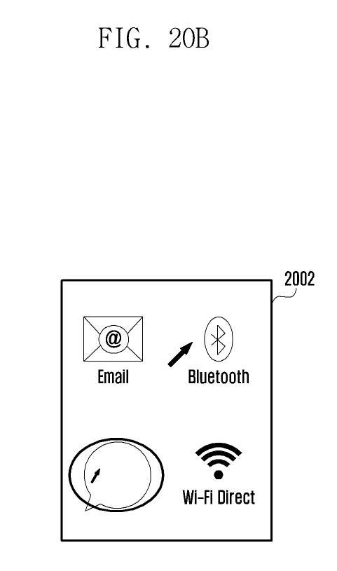

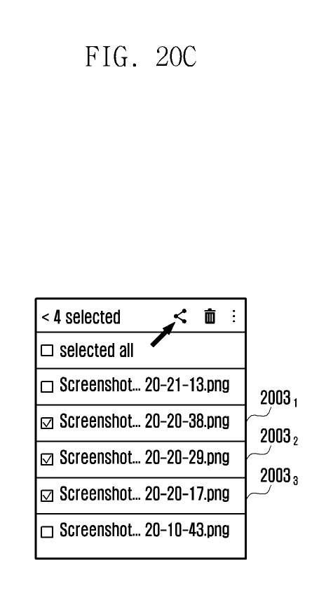

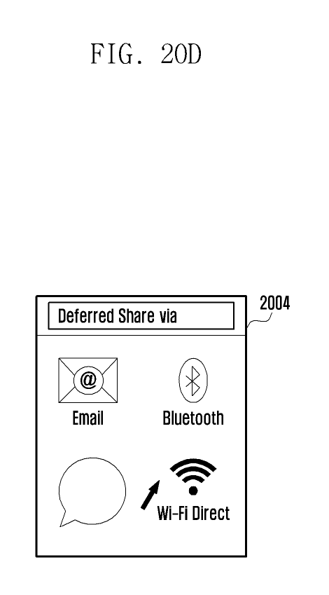

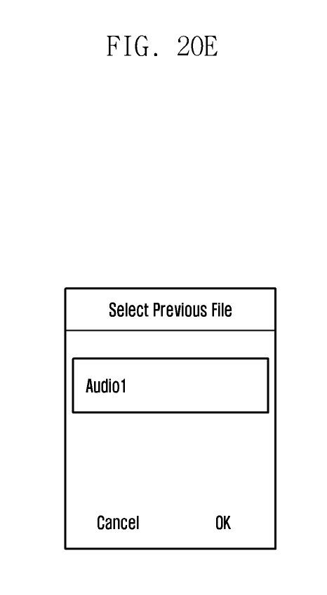

It is possible to transfer different types of digital content using a deferred transmission method. By way of example, FIGS. 20A to 20E show deferred transmission of audio files.

FIGS. 20A to 20E illustrate a schematic flow diagram of a method of deferred audio transmission via a short range communication mode according to an embodiment of the present disclosure.

Referring to FIGS. 20A to 20E, a method substantially similar to the method as illustrated in FIGS. 19A to 19E except for the type of content thus chosen for deferred transmission is provided. In the embodiment of FIGS. 20A to 20E, the type of content is audio file(s) (2003₁, 2003₂, 2003₃), which may be chosen using GUI 2001, and the communication mode chosen for the deferred transmission is Wi-Fi Direct (2004), which may ultimately be chosen starting with GUI 2002.

It may be noted that any type of media content, including audio files, image files, graphical files, video file, animation files, etc. can be sent using the deferred transmission method. One advantage of having such a provision is that the new file will work as an extension to the previously exchanged file.

Additionally, it is possible to adopt the route of creating a deferred directory (as illustrated and described with reference to FIGS. 16A, 17A and 18A above) and transmit the deferred directory using short range communication modes. For example, the traditional file exchange methods such as BT, Wi-Fi, WiFi-Direct etc., can be employed to pass a deferred content such as a deferred directory to the other mobile phone. This deferred directory will serve to provide more features as compared to the traditional file exchanges and also will be intuitive and provide ease of use to the sender as well as the receiver. It is believed that sharing the files through a deferred directory method would allow the sender to later on add a new file to the same directory on the receiver's file system (provided it is not deleted by the user till then).

While in the above paragraphs, a few methods of implementing the deferred transmission method using short range communication modes have been described with reference to FIGS. 19A to 19E and 20A to 20E, the method can be implemented by other alternative methods and the scope of the present disclosure is not limited to the implementation details as provided above.

In the above paragraphs, the method as performed for deferred transmission by the sender device has been described. In the following paragraphs, a deferred data receiving method as performed by a recipient device will be described.

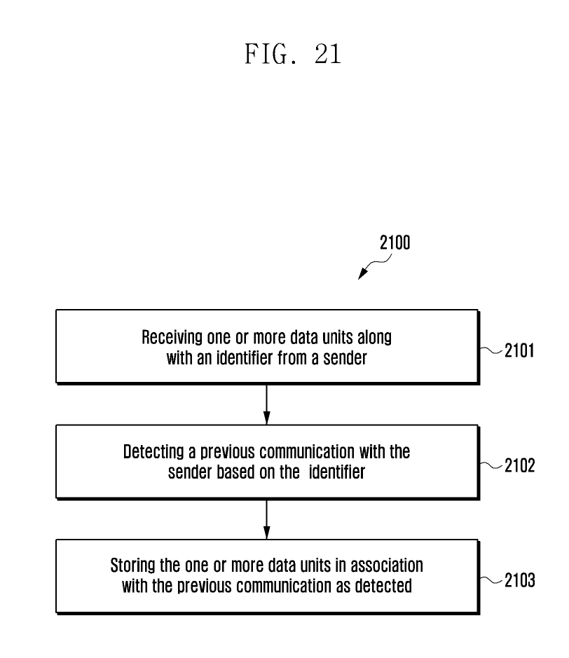

FIG. 21 illustrates a flowchart of a method of deferred data reception according to an embodiment of the present disclosure.

Referring to FIG. 21, the present disclosure further provides a deferred data receiving method (2100) that comprises receiving one or more data units along with an identifier from a sender at operation 2101. Based on the identifier, a previous communication with the sender may be detected at operation 2102 and the one or more data units may be stored at operation 2103 in association with the previous communication thus detected. The identifier may be selected from a group of a transaction identity, an application identity, a context identity (i.e. at least part of data previously transmitted such as a title of an email, a subject, a user's comments, an attached file name and so on), or a combination thereof.

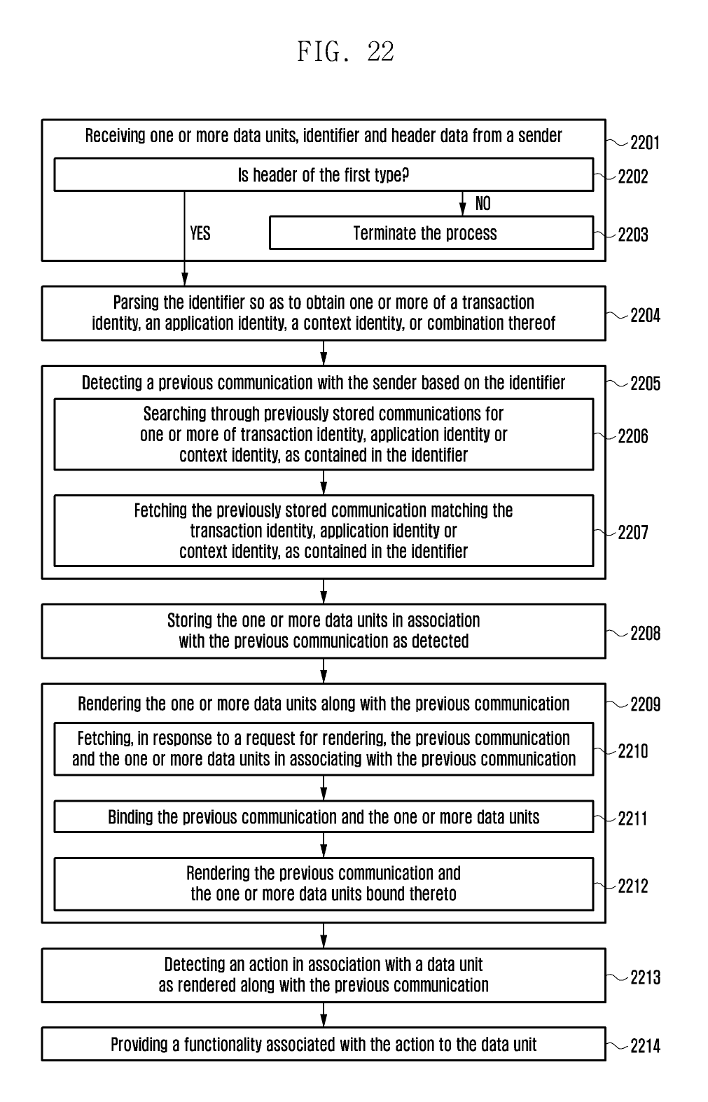

The method as illustrated in FIG. 21 can be supplemented with additional operations as illustrated in FIG. 22.

FIG. 22 illustrates a flowchart of a method of deferred data reception according to an embodiment of the present disclosure.

Referring to FIG. 22, the method (2200) may comprise receiving at operation 2201 header data along with the one or more data units and the identifier, wherein the header data is either of a first type indicating that the one or more data units being transmitted includes a link to a previous communication or a second type indicating that the one or more data units being transmitted does not have any link to a previous communication.

In another embodiment, the method further comprises analyzing the header at operation 2202 and in case the header is of the first type (i.e. indicating the one or more data unit being transmitted includes a link to a previous communication), then a process of detecting a previous communication with the sender at operation 2205 may be performed. In another embodiment, if the header is present and is of the second type (i.e. indicating the one or more data units being transmitted does not have a link to any previous communication), then the process is terminated at operation 2203 and the normal processing (as per of the related art) may be taken.

In yet another embodiment of the present disclosure, the method (2200) may further comprise parsing at operation 2204 the identifier so as to obtain one or more of a transaction identity, an application identity, a context identity, or a combination thereof as contained in the identifier.

In still another embodiment of the present disclosure, the detecting at operation 2205 may further comprise searching at operation 2206 through previously stored communications for one or more of a transaction identity, an application identity or a context identity, as contained in the identifier and fetching at operation 2207 the previously stored communication matching the transaction identity, application identity or context identity, as contained in the identifier. In operation 2208, the one or more data unit may be stored in association with the previous communication.

In a further embodiment of the present disclosure, the method (2200) may further comprise rendering at operation 2209 the one or more data units along with the previous communication. In one embodiment, the rendering at operation 2209 may comprise fetching at operation 2210, in response to a request for rendering, the previous communication and the one or more data units associated with the previous communication. The previous communication and the one or more data units may be then bound together at operation 2211 and rendered at operation 2212. If the one or more data units carry a comment therewith, the previous communication, the one or more data units and the comment associated with the one or more data units are bound together and rendered. In an embodiment, the comment may be associated with the data unit by embedding the comment as metadata of the data unit. In an alternative, if the one or more data units carry a comment therewith, the previous communication, the one or more data units and the comment associated with the one or more data units are bound together. The previous communication and the one or more data units may be rendered at first. Thereafter, the comment may be rendered in response to detecting a predetermined type of action.

In a further embodiment of the present disclosure the method (2200) may further comprise detecting at operation 2213 an action in association with a data unit as rendered along with the previous communication, and providing at operation 2214 a functionality associated with the action to the data unit.

By way of a non-limiting example, the action may be a right swipe on the data unit as rendered along with the previous communication and the functionality may be forwarding the data unit. By way of yet another non-limiting example, the action is a left swipe on the data unit as rendered along with the previous communication and the functionality is a reply to the sender with the data unit.

In the following paragraphs different types of implementations of the deferred receiving method are described along with reference to the corresponding figures. The different implementations being described herein after are merely for illustration purposes and the same should not be construed to limit the scope of the claims in any manner

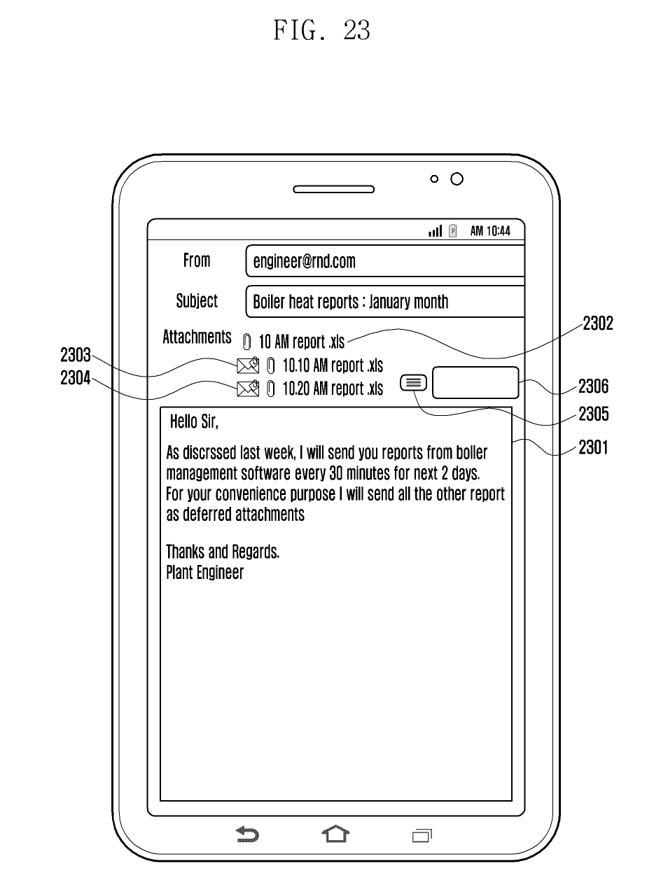

FIG. 23 illustrates a sample rendering of an e-mail along with a deferred attachment according to an embodiment of the present disclosure.

Referring to FIG. 23, there is illustrated a sample rendering of an e-mail along with the deferred attachment in accordance with an embodiment of the present disclosure. As can be observed, the body of the previous e-mail communication is rendered in portion 2301. In case the previous e-mail contained any attachment, the same is rendered in portion 2302. After that, the attachments which are received via the deferred transmission method may be rendered as 2303, 2304 and so on, depending upon the time of receipt. By way of example, it can be seen that the original e-mail is received at 10:00 AM, the first deferred attachment 2303 is received at 10:10 AM and a second deferred attachment 2304 is received at 10:20 AM. In the illustrated example, the second deferred attachment contains a comment and hence, a small indication 2305 indicating the comment is provided as against the second deferred attachment 2304. The indication 2305 may be displayed in the form of an icon on the GUI. In response to detecting a specific type of pre-configured action by the user, the comment may be displayed as 2306.

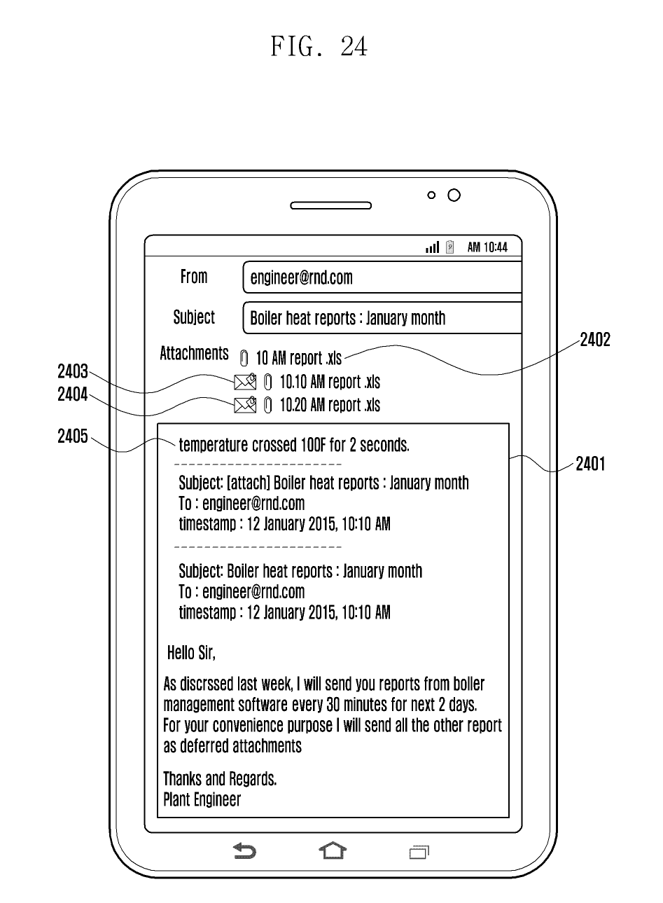

FIG. 24 illustrates a sample rendering of an e-mail along with a deferred attachment according to an embodiment of the present disclosure.

Referring to FIG. 24, there is illustrated yet another sample rendering of an e-mail along with the deferred attachment in accordance with another embodiment of the present disclosure. Similar to FIG. 23, the body of the previous e-mail communication is rendered in portion 2401, the attachment to the previous e-mail communication is rendered at portion 2402. The attachments which are received via the deferred transmission method are rendered as 2403 and 2404. The difference between FIGS. 23 and 24 is in terms of the display of the comments. In FIG. 24, the comment 2405 may be automatically displayed as part of the e-mail body, without any further action.

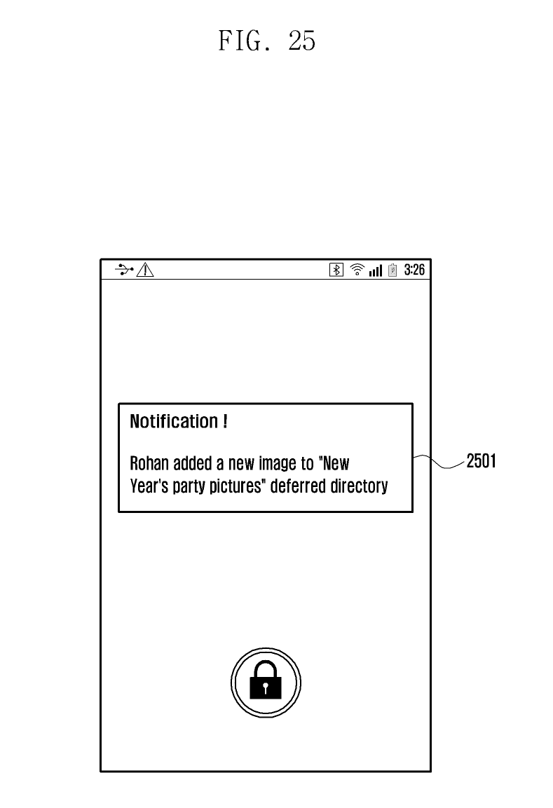

FIG. 25 illustrates a sample notification as provided on a receiver device in response to receiving deferred data via an instant messaging system according to an embodiment of the present disclosure.

Referring to FIG. 25, there is illustrated a sample notification as provided on the receiver device in response to receiving a deferred data via an instant messaging system in accordance with another embodiment of the present disclosure. The notification 2501 may be generated upon receipt of the deferred data unit. In case the deferred data unit contains any comment, the notification can be configured to provide a pre-view of the same. Similarly, in case of an update of a deferred directory, the notification can be configured to mention the name of the directory that has been updated.

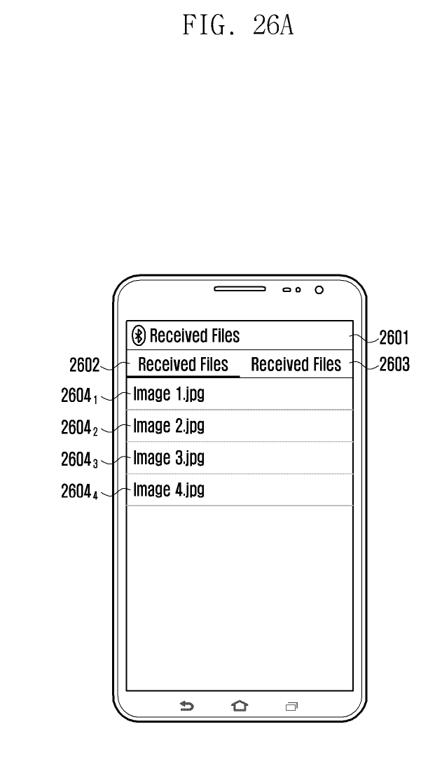

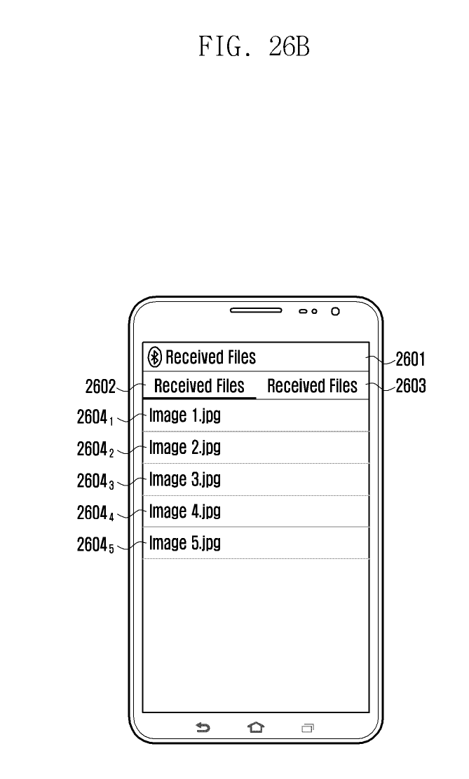

FIGS. 26A and 26B illustrate a sample rendering of multiple deferred directories as received via a short range communication mode according to an embodiment of the present disclosure.

Referring to FIG. 26A, there is illustrated a GUI 2601 which can render details of the first directory 2602 and details of the second directory 2603. Assuming that a first instance the first directory 2602 has been shared with 4 contents namely 2604₁ to 2604₄, details or preview of these contents may be rendered. Now referring to FIG. 26B, when the sender uploads a fresh content to any of the first or the second directory, the sharing can occur. Assuming that after addition of one content 2604₅ to the first directory 2602 the sharing occurred, it can be seen from FIG. 26B that the content 2604₅ now appears within the first directory at the recipient device.

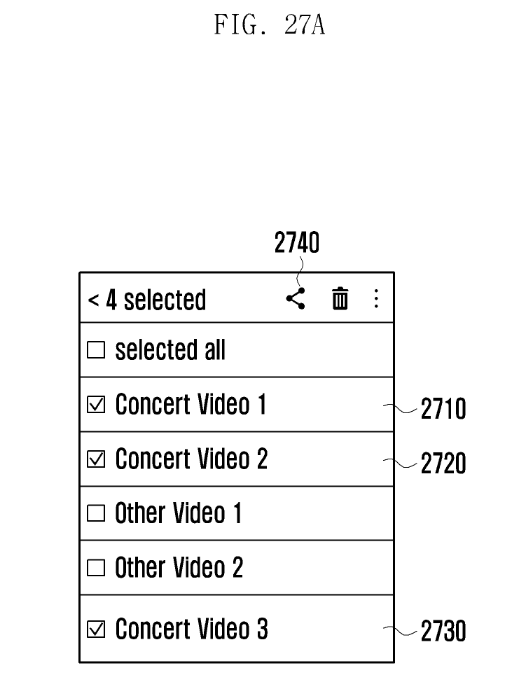

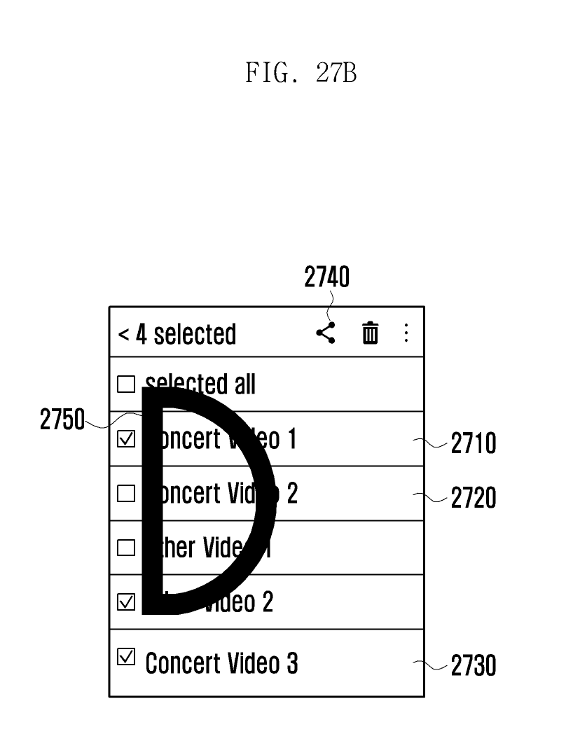

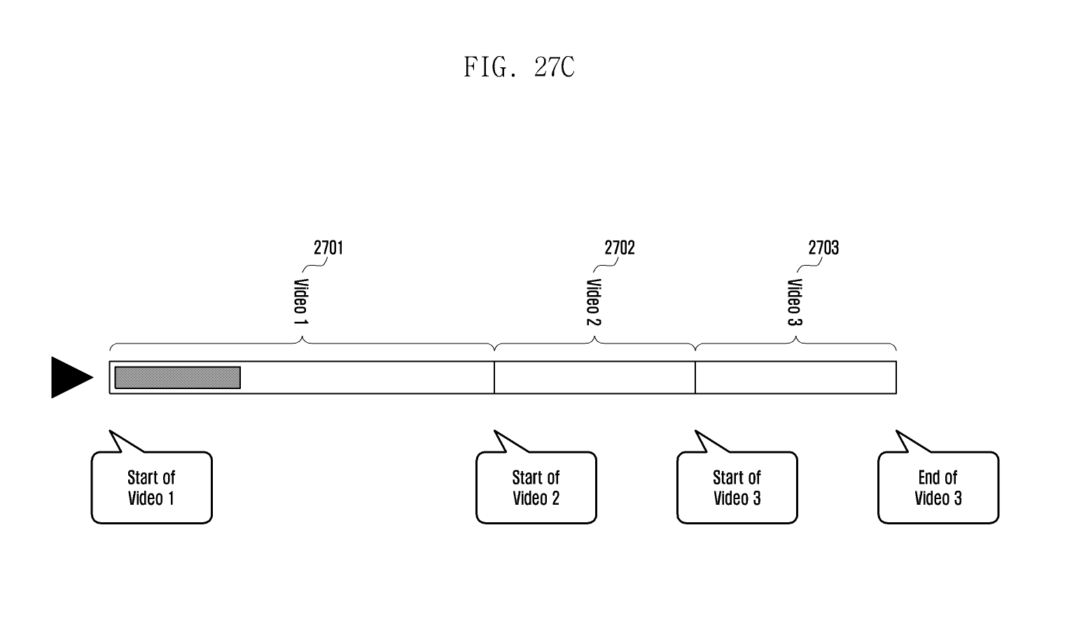

FIGS. 27A to 27C illustrate a sample rendering of a reconstituted video file according to an embodiment of the present disclosure.

Referring to FIGS. 27A to 27C, there is illustrated an embodiment for sharing a deferred media file. The sender (device) can establish a connection with a recipient (device) using a communication network and provide the recipient with a media file. Thereafter, the sender may further send to the recipient one or more files as the deferred media file along with an indication for identifying a relation between the first sent media file and the deferred media file. For example, as shown in FIG. 27A, a media file 2710 is selected at first and sent to the recipient. Thereafter, media files 2720 and 2730 can be additionally selected and sent to the recipient. For example, the user may select an option 2740 concerning “deferred sharing”. Alternatively, the selection may be received in the form of a pattern input “D” 2750 as shown in FIG. 27B. The indication may be appended as an UID into metadata in each deferred media file. Especially when it comes to media data files, at the time of rendering the deferred data units, it is possible to constructively add media files to a previously exchanged media data file. Once a file is marked as deferred, media is constructively added to a previously exchanged media file, then a deferment aware media player can play the files as belonging to a single entity and there would be no pause or delay between ending of a first video to the start of the next video which is deferred to the previous one. In one embodiment as illustrated in FIG. 27C, two video files namely 2702 and 2703 have been shown as added to a previously exchanged media file 2701. Using the constructive addition, the previously exchanged media file and the media file, which is exchanged as a deferred media file, can share a single progress bar, with an indication as to a beginning and an end of each media file.

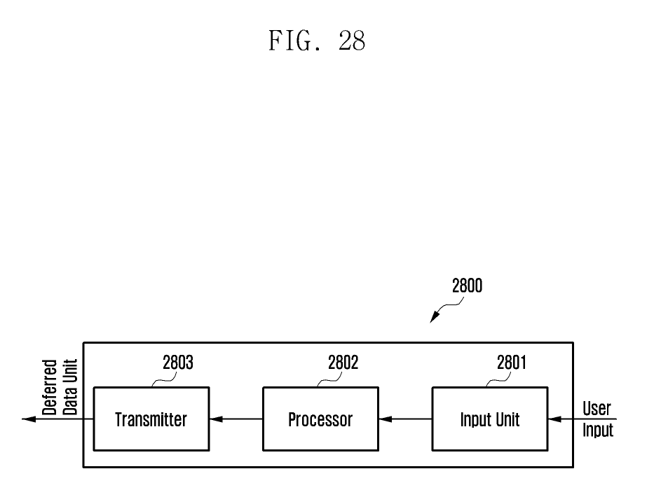

In terms of the system, the present disclosure provides a computing device which will be described with reference to FIG. 28, which is adapted for deferred data transmission.

FIG. 28 illustrates a block diagram of a computing device adapted for implementing a deferred transmission method according to an embodiment of the present disclosure.

Referring to FIG. 28, a computing device 2800 can include an input unit (2801) for receiving one or more data units for deferred transmission to a recipient, a processor (2802) for associating an identifier with the one or more data units based on details of a previous communication with the recipient, and a transmitter unit (2803) for sending the one or more data units along with the identifier thus associated thereto to the recipient.

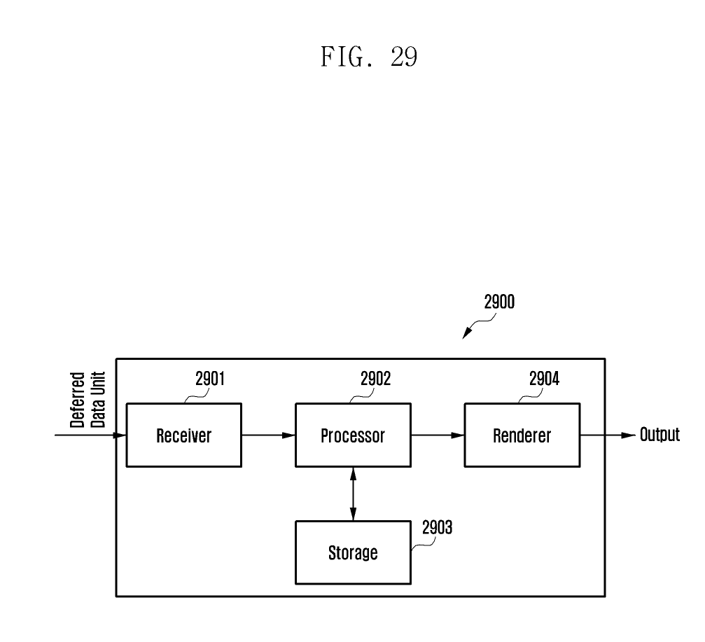

Likewise, the present disclosure provides a computing device as illustrated in FIG. 29, which is adapted for deferred data reception.

FIG. 29 illustrates a block diagram of a computing device adapted for implementing a deferred reception method according to an embodiment of the present disclosure.

Referring to FIG. 29, a computing device 2900 can include a receiver unit (2901) for receiving one or more data units along with an identifier from a sender, a processor (2902) for detecting a previous communication with the sender based on the identifier, and a memory unit (2903) for storing the one or more data units in association with the previous communication as detected. In addition to the above, the computing device can comprise a renderer (2904) for rendering the digital content.

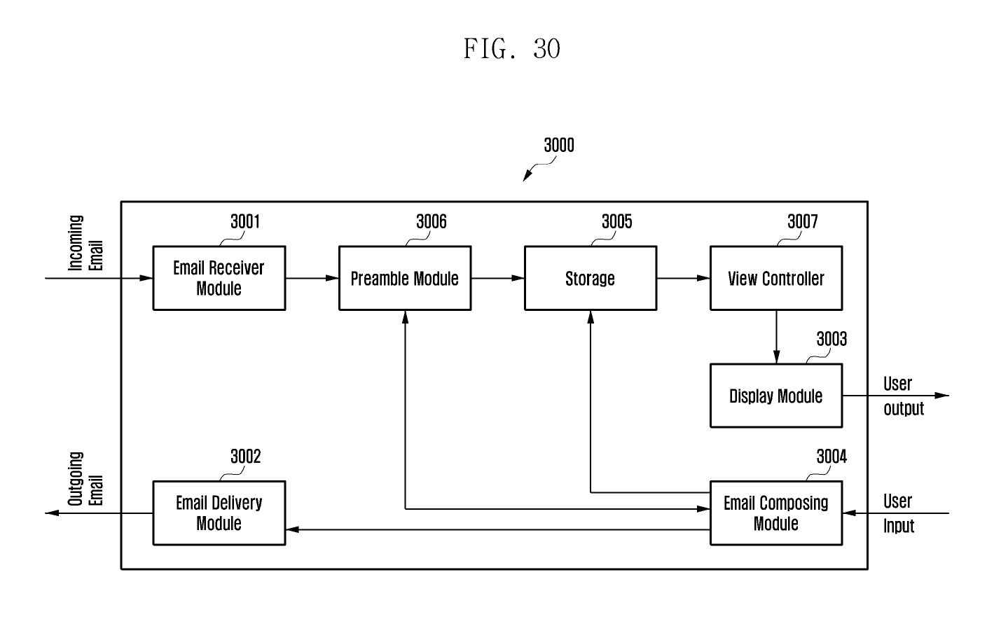

FIG. 30 illustrates a block diagram of an e-mail system adapted for implementing a deferred communication method according to an embodiment of the present disclosure.

Referring to FIG. 30, there is provided an e-mail system (3000) for implementing a deferred communication method in accordance with an embodiment of the present disclosure. The e-mail system comprises of an email receiver module (3001) for handling reception related tasks for e-mail. The e-mail system further comprises an e-mail delivery module (3002) for handling the email delivery related task for emails from networking perspective. There is further provided a display module (3003) for providing a user a visible display environment for the user to be able to see the stored emails (sent/received etc.). There is also provided an e-mail composing module (3004) to support the user in writing of new e-mails. The email system further comprises a storage unit (3005) for storing the e-mails. The e-mail system further comprises a preamble module (3006). The preamble module (2006) is responsible for pre-processing of the email in order to convert it to a format which complies with the format used by the storage media implementation. This module checks for the deferment indication bits and accordingly puts the entry in storage unit (3005). If the email is from a deferment non-aware system, it assumes that both of the deferment indication bits are zero. The e-mail system furthermore comprises a view controller (3007). The view controller (3009) provides the display instructions to the display module 3003). This controller has the information about the deferment emails and accordingly can ask the display module (3003) to indicate an attachment as a deferred item to a previous communicated message.

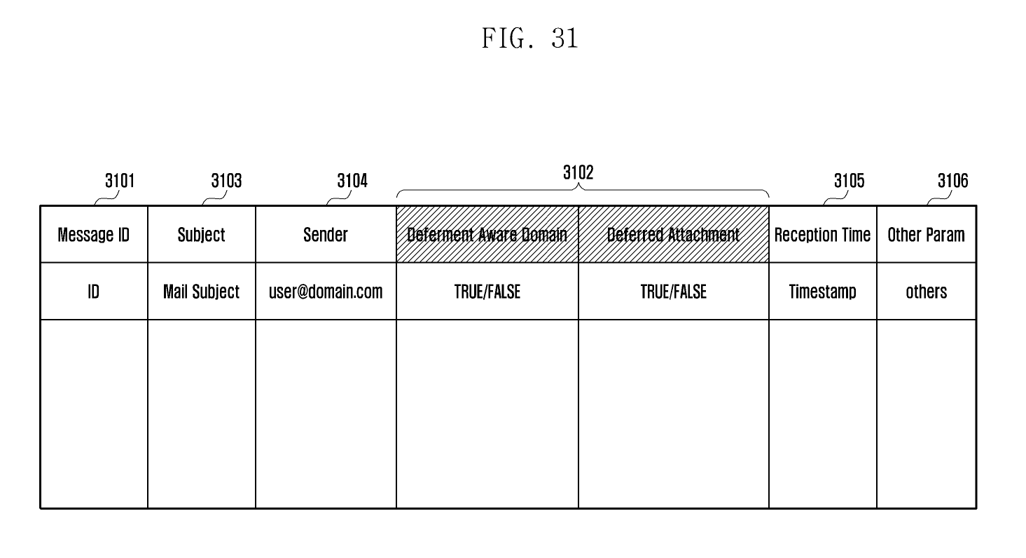

FIG. 31 shows a general storage entry in a receiver side email handling system according to an embodiment of the present disclosure.

Referring to FIG. 31, in respect of each communication message, a message ID (3101) functions as a unique identity. The message storage entry further comprises deferment indication bits (3102). Based on the contents (or presence) of the deferment indication bits, the preamble module and the view controller can take a decision of the nature of processing. The message storage entry may further store an indication of the subject (3103), details of the sender (3104), a time of reception of the e-mail (3105) and other parameters (3106). The preamble module will handle incoming emails from a deferment aware as well as a deferment non-aware system. Accordingly, the handled cases are described below.

Below is described an occurrence of receipt of an email from a deferment aware system without any deferred attachment.

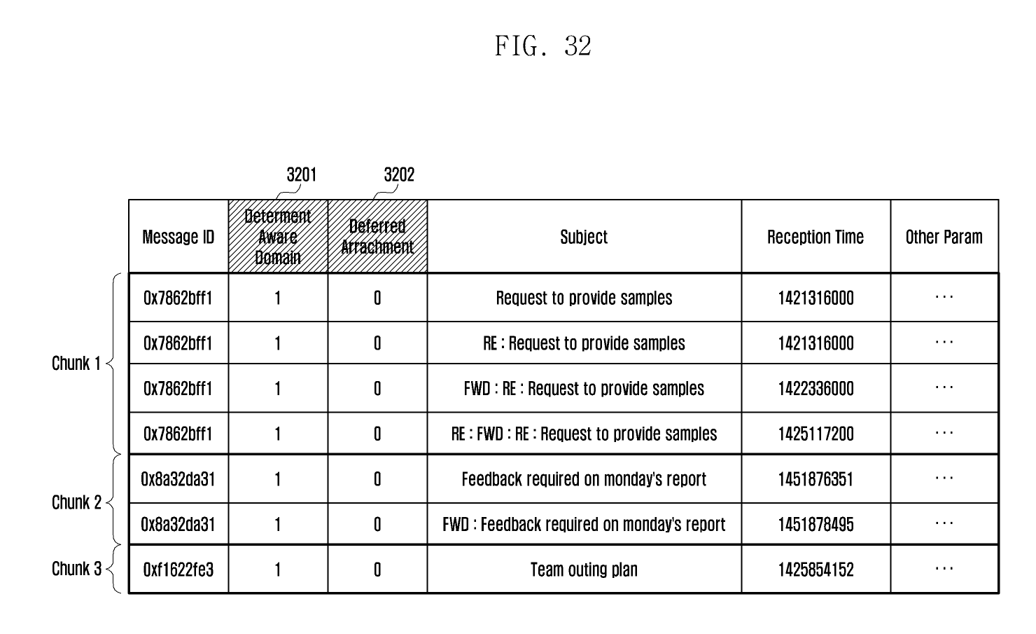

In this case, the contents of the storage will be as shown in FIG. 32.

FIG. 32 illustrates storage entries of emails from a deferment aware system without any deferred attachment according to an embodiment of the present disclosure.

Referring to FIG. 32, the emails are grouped in the form of chunks, with each chunk having one unique message ID for all its communicated messages. The example shows three email chunks—Chunk 1, Chunk 2 and Chunk 3. None of the chunks has any particular email that carries the deferred attachment. Hence, a bit of the deferred attachment field 3202 is set to 0, while a bit of the deferment aware system 3201 is set to 1.

Below is described an occurrence of receipt of an email from a deferment aware system carrying a deferred attachment.

In this case, the deferred attachment bit for all the emails which were marked by the sender as carrying a deferred attachment are set to 1.

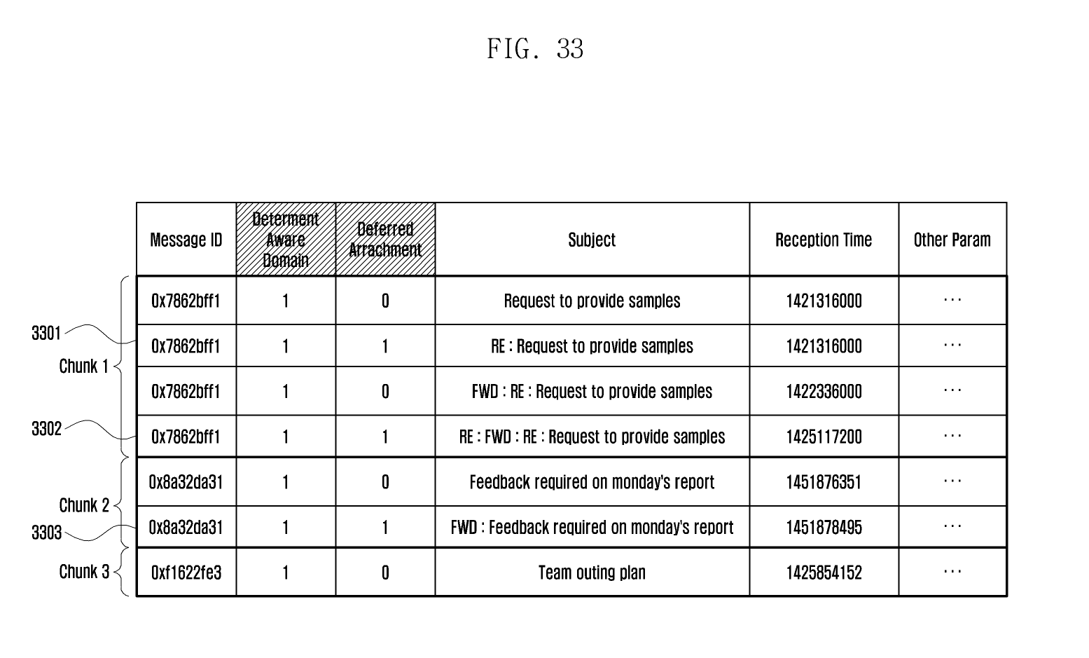

FIG. 33 illustrates storage entries of emails from a deferment aware system with deferred attachments according to an embodiment of the present disclosure.

Referring to FIG. 33, two emails (3301 and 3302) in a first chunk to be carrying a deferred attachment are shown, while one email (3303) in the second chunk to be carrying a deferred attachment is shown. In light of the above, the deferred attachment field corresponding to the e-mails 3301, 3302 and 3303 are set as 1.

Below is described an occurrence of receipt of an email from a deferment non-aware system without any deferred attachment.

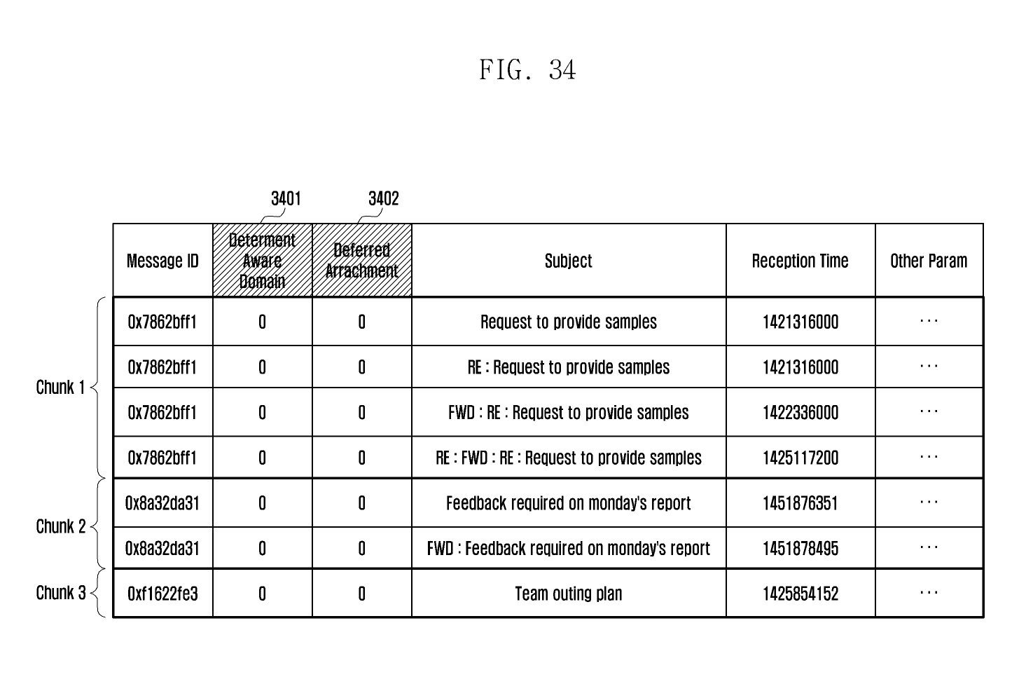

FIG. 34 illustrates storage entries of emails from a deferment non-aware system without any deferred attachment according to an embodiment of the present disclosure.

Referring to FIG. 34, the deferment aware system bit is set to zero, as well as the deferred attachment bit is set to zero. This is done by the preamble module because the email did not carry any such bits in the message header, hence the deferment aware system field (3401) are given the default value of zero.

Additionally, the deferred attachment field (3402) is also set to zero.

Below is described an occurrence of receipt of an email from a deferment non-aware system carrying a deferred attachment.

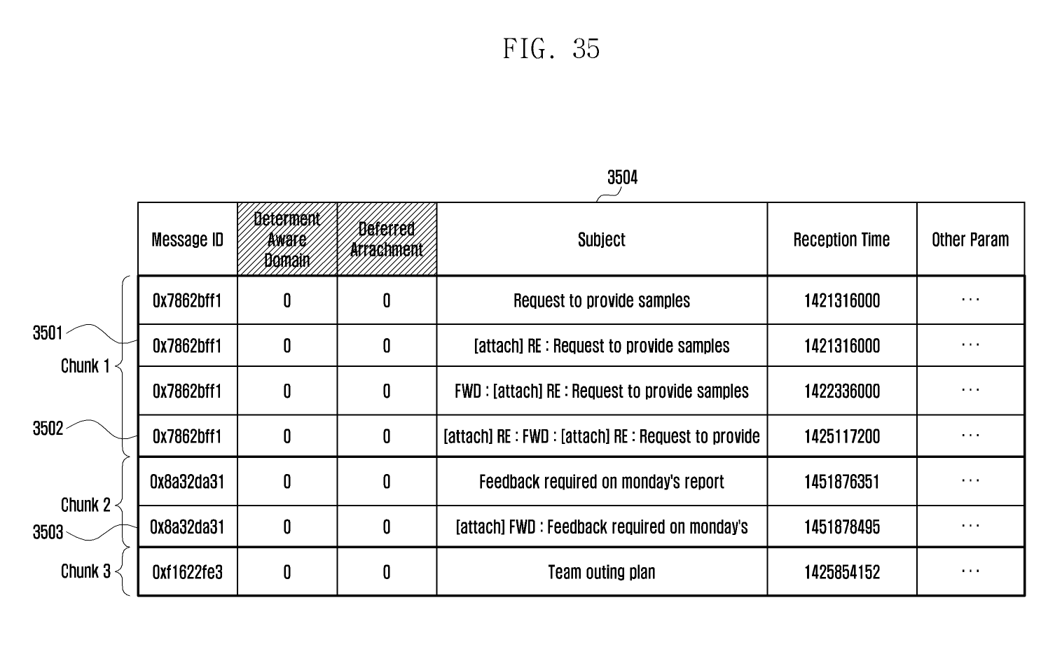

FIG. 35 illustrates storage entries of emails from a deferment non-aware system with deferred attachments according to an embodiment of the present disclosure.

Referring to FIG. 35, in the case of an e-mail from a deferment non-aware system carrying a deferred attachment, the deferment aware system bit along with the deferred attachment bit is set to zero, as none of the two indications was present in the message header, so they are given their default value of zero. Now to provide backward compatibility, the emails can be distinguished on the basis of their subject text, i.e. any subject with special prefix “[attach]” is handled as a deferred attachment type email.

Thus, the e-mails 3501, 3502 and 3503 can be distinguished on the basis of the special prefix “[attach]” as contained in the subject field (3504). This handling can be done either by the preamble module or at view controller level.

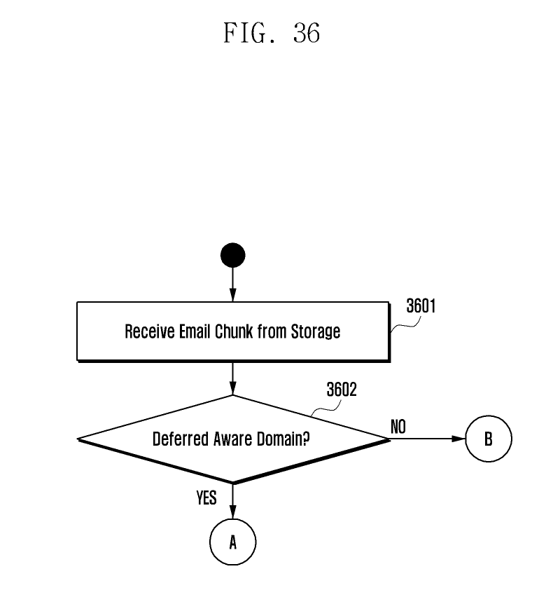

FIG. 36 illustrates a flowchart of a process as implemented by a view controller for detecting whether an e-mail comes from a deferment aware system or a deferment non-aware system according to an embodiment of the present disclosure.

Referring to FIG. 36, the view controller may pick up each chunk from storage at operation 3601 and, for each email to be displayed, verify at operation 3602 if the email is from deferment aware systems by checking the deferment aware domain bit in the storage entry.

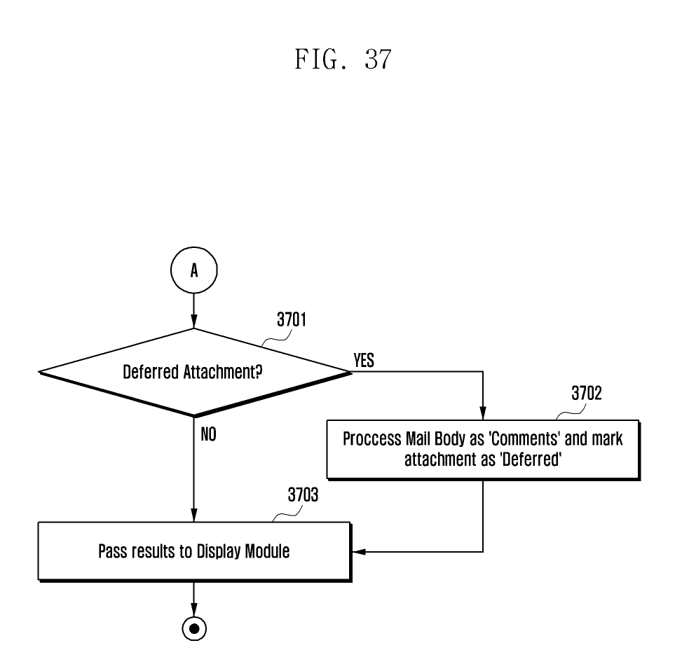

FIG. 37 illustrates a flowchart of a process as implemented by a view controller for detecting deferred attachments in case an e-mail comes from a deferment aware system according to an embodiment of the present disclosure.

Referring to FIG. 37, if the sender domain is deferment aware then the email may be checked at operation 3701 for carrying any deferred attachments. In case the e-mail is found to be carrying deferred attachment(s), as marked by a deferred attachment bit in the storage, special handling instructions may be generated at operation 3702 and the controller may pass at operation 3703 on special handling instructions to the display module. The special handling instruction pertains to display instructions.

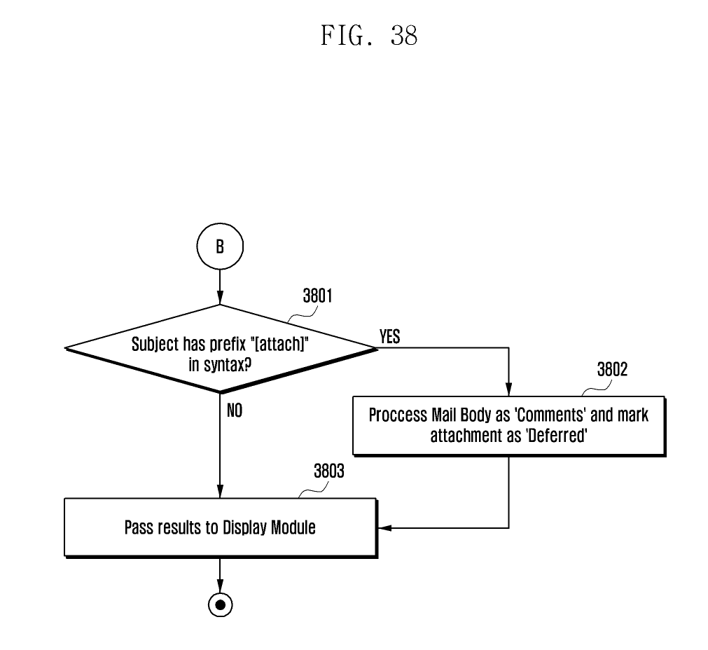

FIG. 38 illustrates a flowchart of a process as implemented by a view controller for detecting deferred attachments in case an e-mail comes from a deferment non-aware system according to an embodiment of the present disclosure.

If in figure FIG. 36 it is determined that the sender domain is deferment non-aware, then the processing proceeds as shown in FIG. 38, wherein the mail subject may be checked at operation 3801 for containing the special syntax (prefix, “[attach]”). In case the e-mail is found to be carrying the special syntax, special handling instructions may be generated at operation 3802 and the controller may pass at operation 3803 on special handling instructions to the display module. The special handling instruction pertains to display instructions.

Below is described an example of pointers for email from deferment aware systems carrying a deferred attachment.

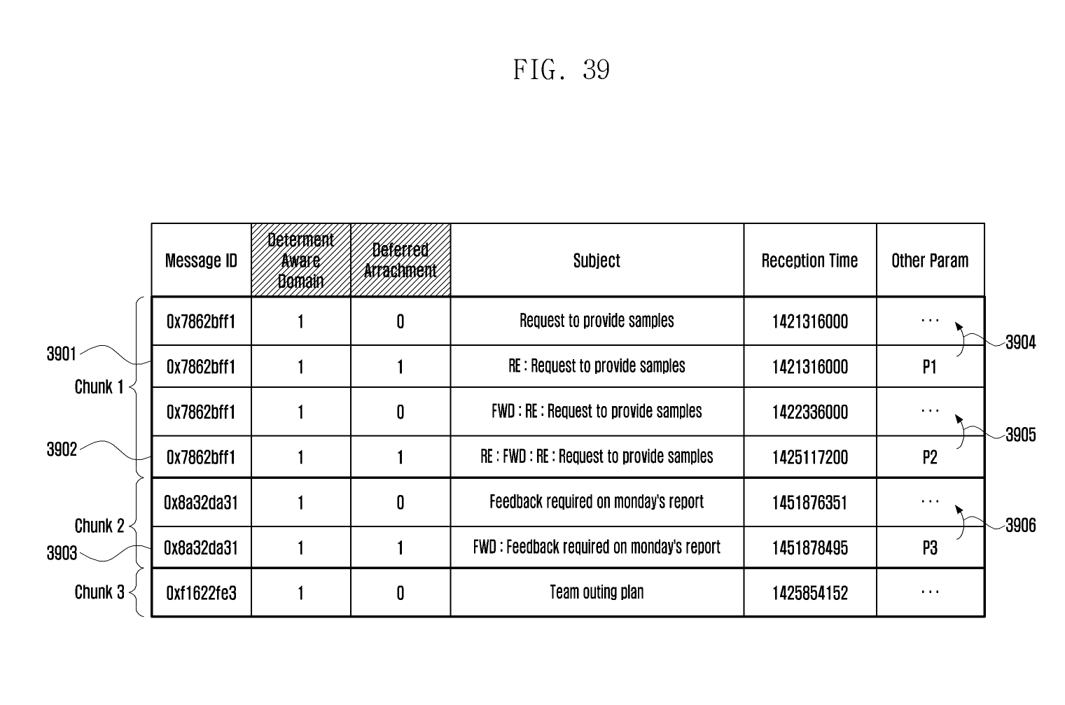

FIG. 39 illustrates a pointer structure in emails with deferred attachments as coming from a deferment aware system according to an embodiment of the present disclosure.

Referring to FIG. 39, new email (3901, 3902 and 3903) which contains deferred attachments carries pointer entity (3904, 3905 and 3906) to the previous email entity to which a new attachment is being added. This pointer is based on the deferred attachment field.

Below is described an example of pointers for mail from deferment non-aware systems carrying deferred attachment.

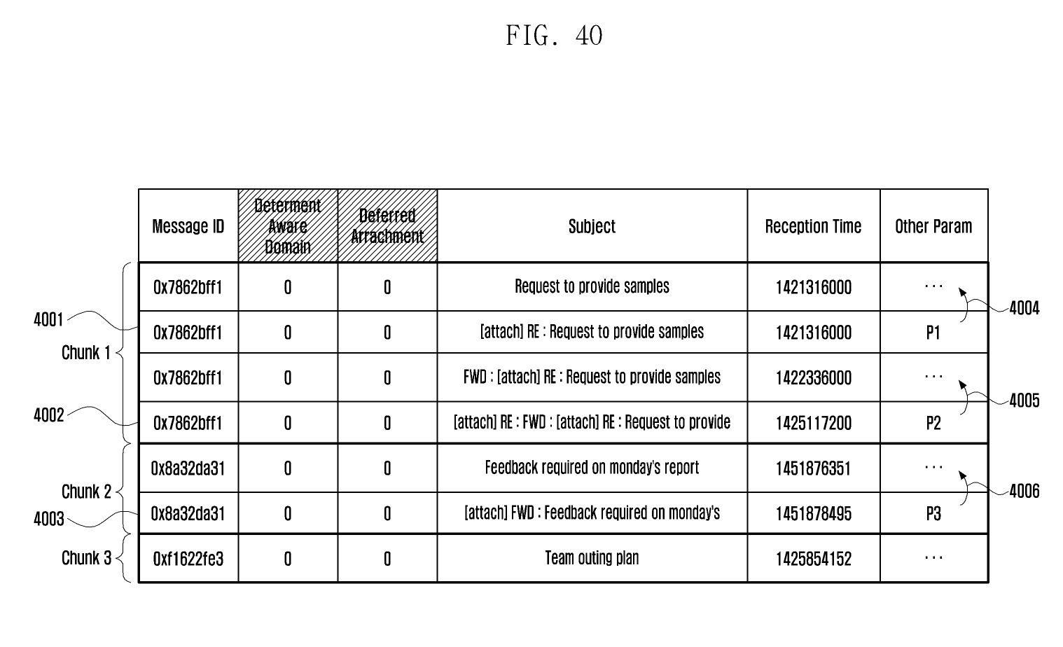

FIG. 40 illustrates a pointer structure in emails with deferred attachments as coming from a deferment non-aware system according to an embodiment of the present disclosure.

Referring to FIG. 40, new mail (4001, 4002 and 4003) which contains deferred attachments carries pointer entity (4004, 4005 and 4006) to the previous email entity to which a new attachment is being added. In this case, the pointer is based on the special syntax as contained in the subject field.

Without being restricted to an e-mail system as described above, a deferred communication method in accordance with an embodiment of the present disclosure can provide a few unique utilities in regard to handling the email attachments.

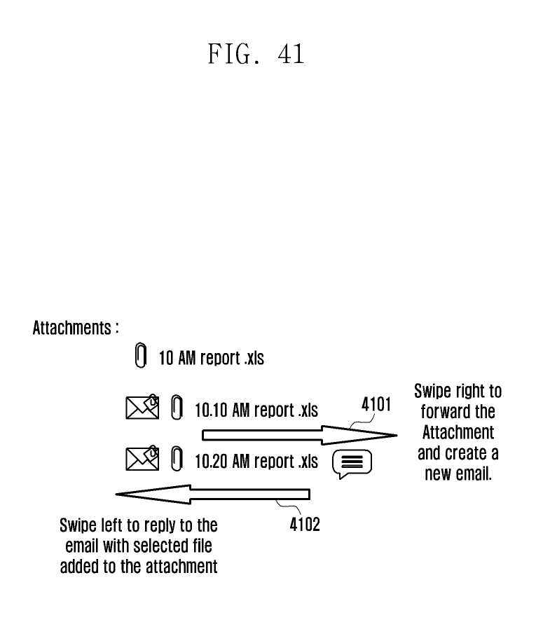

FIG. 41 illustrates unique utilities that can be included while handling email attachments in an e-mail system implementing a deferred communication method according to an embodiment of the present disclosure.

Referring to FIG. 41, in response to detecting a swiping right action or gesture (4101) on an attachment, a new email can be created and the swiped attachment added to the newly created mail as an attachment. This provides for ease of use to the user when the user wants to send only one attachment out of a number of attachments to some other users. By way of another example, in response to detecting a swiping left action or gesture (4102) on an attachment, an email including the swiped attachment in reply to the original sender of the email in the recipients section can be created. This provides ease of use to the user when the user wants to reply to the user keeping a particular attachment in context while replying.

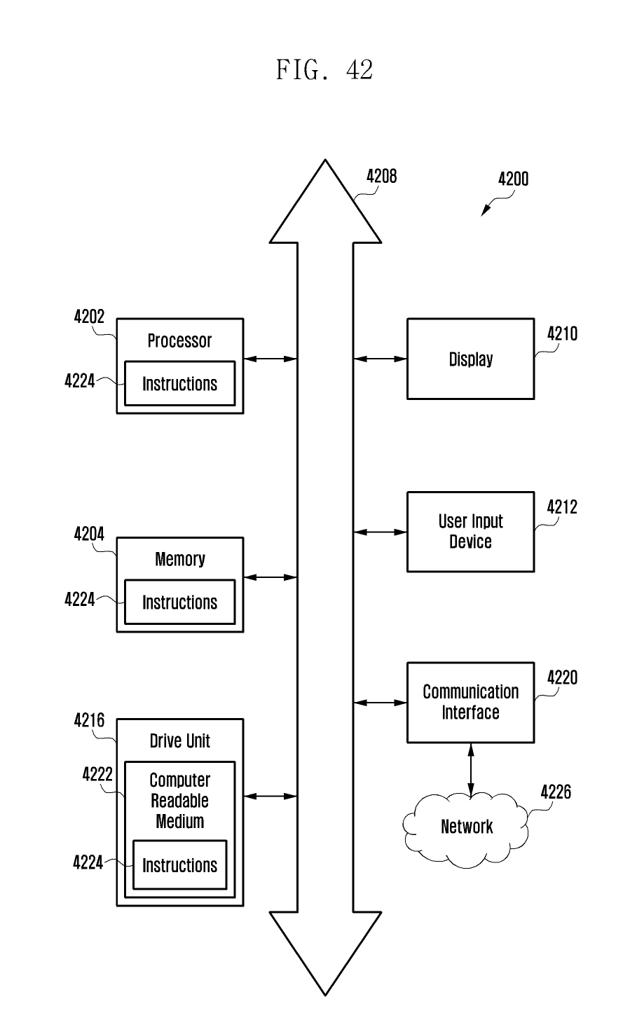

FIG. 42 illustrates a typical hardware configuration of the computing device according to an embodiment of the present disclosure.

Referring to FIG. 42, a typical hardware configuration of a computing device in the form of a computer system 4200 is shown. The computer system 4200 can include a set of instructions that can be executed to cause the computer system 4200 to perform any one or more of the methods disclosed. The computer system 4200 may operate as a standalone device or may be connected, e.g., using a network, to other computer systems or peripheral devices.

In a networked deployment, the computer system 4200 may operate in the capacity of a server or as a client user computer in a server-client user network environment, or as a peer computer system in a peer-to-peer (or distributed) network environment. The computer system 4200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine Further, while a single computer system 4200 is illustrated, the term “system” shall also be taken to include any collection of systems or sub-systems that individually or jointly execute a set, or multiple sets, of instructions to perform one or more computer functions.

The computer system 4200 may include a processor 4202, e.g., a central processing unit (CPU), a graphics processing unit (GPU), or both. The processor 4202 may be a component in a variety of systems. For example, the processor 4202 may be part of a standard personal computer or a workstation. The processor 4202 may be one or more general processors, digital signal processors, application specific integrated circuits, field programmable gate arrays, servers, networks, digital circuits, analog circuits, combinations thereof, or other now known or later developed devices for analyzing and processing data The processor 4202 may implement a software program, such as code generated manually (i.e., programmed).

The computer system 4200 may include a memory 4204, such as a memory 4204 that can communicate via a bus 4208. The memory 4204 may be a main memory, a static memory, or a dynamic memory. The memory 4204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 4204 includes a cache or random access memory for the processor 4202. In alternative examples, the memory 4204 is separate from the processor 4202, such as a cache memory of a processor, the system memory, or other memory. The memory 4204 may be an external storage device or database for storing data. Examples include a hard drive, compact disc (CD), digital video disc (DVD), memory card, memory stick, floppy disc, universal serial bus (USB) memory device, or any other device operative to store data. The memory 4204 is operable to store instructions executable by the processor 4202. The functions, acts or tasks illustrated in the figures or described may be performed by the programmed processor 4202 executing the instructions stored in the memory 4204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 4200 may or may not further include a display unit 4210, such as a liquid crystal display (LCD), an organic light emitting diode (OLED), a flat panel display, a solid state display, a cathode ray tube (CRT), a projector, a printer or other now known or later developed display device for outputting determined information. The display 4210 may act as an interface for the user to see the functioning of the processor 4202, or specifically as an interface with the software stored in the memory 4204 or in a drive unit.

Additionally, the computer system 4200 may include an input device 4212 configured to allow a user to interact with any of the components of system 4200. The input device 4212 may be a number pad, a keyboard, or a cursor control device, such as a mouse, or a joystick, touch screen display, remote control or any other device operative to interact with the computer system 4200.

The computer system 4200 may also include a disk or optical drive unit 4216. The disk drive unit 4216 may include a computer-readable medium 4222 in which one or more sets of instructions 4224, e.g. software, can be embedded. Further, the instructions 4224 may embody one or more of the methods or logic as described. In a particular example, the instructions 4224 may reside completely, or at least partially, within the memory 4204 or within the processor 4202 during execution by the computer system 4200. The memory 4204 and the processor 4202 also may include computer-readable media as discussed above.

The present disclosure contemplates a computer-readable medium that includes instructions 4224 or receives and executes instructions 4224 responsive to a propagated signal so that a device connected to a network 4226 can communicate voice, video, audio, images or any other data over the network 4226. Further, the instructions 4224 may be transmitted or received over the network 4226 via a communication port or interface 4220 or using a bus 4208. The communication port or interface 4220 may be a part of the processor 4202 or may be a separate component. The communication port 4220 may be created in software or may be a physical connection in hardware. The communication port 4220 may be configured to connect with a network 4226, external media, the display 4210, or any other components in system 4200, or combinations thereof. The connection with the network 4226 may be a physical connection, such as a wired Ethernet connection or may be established wirelessly as discussed later. Likewise, the additional connections with other components of the system 4200 may be physical connections or may be established wirelessly. The network 4226 may alternatively be directly connected to the bus 4208.

The network 4226 may include wired networks, wireless networks, Ethernet AVB networks, or combinations thereof. The wireless network may be a cellular telephone network, an 802.11, 802.16, 802.20, 802.1Q or WiMax network. Further, the network 426 may be a public network, such as the Internet, a private network, such as an intranet, or combinations thereof, and may utilize a variety of networking protocols now available or later developed including, but not limited to transmission control protocol (TCP)/Internet protocol (IP) based networking protocols.

In an alternative example, dedicated hardware implementations, such as application specific integrated circuits, programmable logic arrays and other hardware devices, can be constructed to implement various parts of the system 4200. Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, user datagram protocol (UDP)/IP, hypertext markup language (HTML), hypertext transfer protocol (HTTP)) may be used. Such standards are periodically superseded by faster or more efficient equivalents having essentially the same functions. Accordingly, replacement standards and protocols having the same or similar functions as those disclosed are considered equivalents thereof.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for transmitting data at an electronic device, the method comprising:
sending first data to an external device;
receiving a selection of second data for transmission to the external device;
associating an identifier with the second data based on the first data; and
sending the second data along with the identifier associated thereto to the external device.

2. The method of claim 1, wherein the identifier comprises at least one of a transaction identity, an application identity, at least part of the first data, or a combination thereof.

3. The method of claim 1, wherein the receiving of the second data for transmission to the external device comprises:
presenting, to a user, a graphical user interface including data units;
receiving a selection of at least one of the data units; and
receiving an indication requesting transmission of the selected at least one data unit.

4. The method of claim 1, further comprising:
presenting, to a user, a first graphical user interface including information relating communication modes supporting transmission of the second data;
receiving a selection of one of the communication modes;
presenting, to a user through a second graphical user interface, details of the first data transmitted through the selected communication mode; and
receiving a selection of the details through the second graphical user interface,
wherein the communication modes include at least one of an e-mail communication mode, a short-range communication mode, and an instant messaging communication mode.

5. The method of claim 1, wherein the receiving of the second data for transmission to the external device further comprises receiving a comment corresponding to the second data.

6. The method of claim 1, wherein a header of the second data comprises a first type indicating the data being transmitted includes a link to the first data.

7. A method for receiving data at an electronic device, the method comprising:
receiving first data including an identifier from an external device;
detecting, in a memory of the electronic device, second data corresponding to the identifier; and
storing the first data in association with the detected second data.

8. The method of claim 7, wherein the identifier comprises at least one of a transaction identity, an application identity, at least part of the first data, or a combination thereof.

9. The method of claim 7, further comprising displaying the first data along with the second data.

10. The method of claim 9, further comprising:
binding the first data and the second data; and
displaying the first data and the second data bound thereto.

11. The method of claim 10, wherein, in case the first data includes an audio data unit, the binding comprises generating a new audio data unit, which includes audio data units of the first data and audio data units of the second data.

12. The method of claim 11, further comprising, while providing the new audio data unit, displaying visual information representing the new audio data unit.

13. The method of claim 10, wherein, in case the first data includes a video data unit, the binding comprises generating a new video data unit, which includes video data units of the first data and video data units of the second data.

14. The method of claim 13, further comprising, while rendering the new video data unit, displaying visual information representing the new video data unit.

15. The method of claim 10, wherein the storing of the first data comprises storing the first data in association with a directory corresponding to the identifier.

16. The method of claim 9, further comprising:
detecting an action in association with the displayed data; and
providing a functionality associated with the action.

17. The method of claim 16, wherein the action comprises a swipe on the displayed data and the functionality is forwarding of an email containing the second data.

18. The method of claim 12, wherein a header of the data indicates that the first data has a link to the second data.

19. An electronic device comprising:
an input device;
a communication interface;
a processor; and
a memory storing computer program instructions configured, working with the processor, to cause the electronic device at least to:
send first data to an external device,
receive a selection of second data for transmission to the external device,
associate an identifier with the second data based on the first data, and
send the second data along with the identifier associated thereto to the external device.

20. An electronic device comprising:
an input device;
a communication interface;
a processor; and
a memory storing computer program instructions configured, working with the processor, to cause the electronic device at least to:
receive first data along with an identifier from an external device,
detect, in a memory of the electronic device, second data corresponding to the identifier, and
store the first data in association with the detected second data.
